(19) United States
(12) Patent Application Publication
(10) Pub. No.: US 2014/0044600 A1
(43) Pub. Date: Feb. 13, 2014

(54) DEVICE FOR TREATING CHEMICAL COMPOSITIONS AND METHODS FOR USE THEREOF

(71) Applicant: McAlister Technologies, LLC, Phoenix, AZ (US)

(72) Inventor: Roy Edward McAlister, Phoenix, AZ (US)

(73) Assignee: McAlister Technologies, LLC, Phoenix, AZ (US)

(21) Appl. No.: 13/966,152

(22) Filed: Aug. 13, 2013

Related U.S. Application Data
(63) Continuation-in-part of application No. 13/584,705, filed on Aug. 13, 2012, now Pat. No. 8,617,399.
(60) Provisional application No. 61/523,228, filed on Aug. 12, 2011.

(51) Int. Cl. B01J 19/08; B01D 50/00; B01D 35/06

(52) U.S. Cl. CPC B01J 19/087; B01D 35/06; B01D 50/00
USPC 422/128; 210/223; 210/175; 96/1; 96/2; 422/186.01

(57) ABSTRACT

Devices for treating chemical compositions of a sample and methods for use thereof are disclosed here. In one embodiment, for example, a device may include a container; an opening; a magnetic component that induces a magnetic field across a portion of the device; and a sorptive media loaded within the container. The device may further comprise a magnetizable fluid loaded within the container. The sorptive media may be configured to filter a composition from a magnetizable fluid. The magnetic field may be configured to drive filtration of the magnetizable fluid containing composition after reacting the composition in order to remove or separate constituents of the composition.

### CROSS-REFERENCE TO RELATED APPLICATION(S)

This application is a continuation-in-part application and claims the benefit of and priority to U.S. patent application Ser. No. 13/584,705, filed Aug. 13, 2012, which claims the benefit of U.S. Provisional Application No. 61/523,228, filed Aug. 12, 2011, both of which are entitled, “DYNAMIC FILTRATION SYSTEM AND ASSOCIATED METHODS,” and both of which are incorporated here by reference in their entirety.

### TECHNICAL FIELD OF THE INVENTION

The present invention relates generally to devices that may be used for treating, e.g., reacting, separating, filtering, or otherwise manipulating, chemical compositions or components of a sample, and to methods associated therewith.

### BACKGROUND OF THE INVENTION

Chemical compositions or components of samples thereof may be treated in various ways. For example, separation is any process that isolates or purifies a mixture of substances into two or more distinct products, where the products may be pure constituents. Separations are carried out based on differences in chemical properties such as size, shape, mass, or chemical affinity between the constituents of a mixture. Separation techniques include centrifugation, chromatography, crystallization, precipitation, distillation, electrophoresis, extraction, filtration, sedimentation, magnetic separation, vapor-liquid separation, etc. These techniques may be useful in numerous industries as well.

Chromatography is a process that may be used to identify or determine whether or not a patient has diabetes by identifying sugar in urine. Centrifugation is a process that may be used, for example, to remove fat from milk to produce skim milk and, in similar fashion, for separating platelets from whole blood. In another example, when a mixture of vapor and liquid is fed or allowed to enter into a vapor-liquid separator vessel, the liquid may be separated by gravity, which accumulates in one area of the vessel, while the vapor migrates to an opposite area of the separator vessel.

Conventional filtration and processing methods are wasteful in that value is not fully achieved from waste. For example, carbon wastes produced by hydrocarbon combustion pollute the air and contribute greatly to the greenhouse gas impact on the climate. However, conventional filtration systems used to intercept and remove particles or substances from a fluid may not realize all of the possible benefits of utilizing all of the components that could be, but are not, separated. Many such filtration systems are typically configured to remove a specific contaminant (e.g., sulfur) or configured for use with a certain type of fluid (e.g., liquid versus gas, oil versus water).

The advancements in technology and the growth of our society have over the years given rise to issues that adversely affect our environment. For example, consumption habits of modern consumer lifestyles are causing a huge worldwide waste problem. Having overfilled local landfill capacities and created dangerous, and even carcinogenic, situations, first-world nations are now exporting their refuse to third world countries. This is having a devastating impact on ecosystems (land, water, and air), and on cultures throughout the world. For example, in a March 2010 report entitled, “Reducing Environmental Cancer Risk: What Do We Do,” a presidential panel concluded the true burden of environmentally induced cancer has been grossly underestimated giving rise to the reality of so-called “cancer clusters.”

Some companies have attempted addressing the issue by developing ways to recycle waste, including the generation of energy from landfill waste and pollution. Others have attempted to develop alternative energy from landfill waste and pollution. However, critical advancements to help our society and the world are not being achieved quickly enough.

Accordingly, there is a need to provide devices that can be adapted to treat, e.g., react, separate, filter, or otherwise manipulate, a variety of different types of substances, e.g., fluids, and, for example, remove a variety of different contaminants from diverse environments. There is also a need to convert products, for example, carbon, from a variety of sources, such as, but not limited to, greenhouse gases, agricultural and industrial wastes, sewage, and landfills, into useful resources and thereby minimize pollution, or to take all of the products from those sources and reclaim their economic, constructive, and environmental values.

### SUMMARY OF THE INVENTION

One object of the present invention is to provide a device for treating, reacting, separating, filtering, or manipulating constituents of a sample, where the device has a container and the container has a reaction chamber or vessel; an opening comprising a channel for receiving a sample into the container; an opening comprising a channel for releasing constituents of the sample from the container; a component that may generate or induce a magnetic field across at least a portion of the container; a magnetizable fluid; and a sorptive media, where the magnetizable fluid and the sorptive media are contained or loaded within the container. More specifically, a device for treating a fluid, comprising: a container having an opening and a magnetic component; and a sorptive media loaded within the container, wherein the sorptive media is positioned relative to the magnetic component so that when the fluid is in the container, the magnetic component exerts a magnetic field on the fluid and the sorptive media.

Another object of the invention is directed to a method of filtering a sample containing constituents for separation by receiving the sample through an opening for receiving a sample into a container of a device; applying a magnetic field across a reaction chamber or vessel of the container containing a magnetizable fluid and a sorptive media; reacting constituents of the sample in the reaction vessel; disengaging the magnetic field; and removing a constituent of the sample generated by the reaction through an opening for releasing constituents from the container. More specifically, the method of treating a fluid comprises the steps of introducing a fluid through an opening for receiving a fluid into a container of a device, where the container comprises a magnetic component and a sorptive media, and the sorptive media is positioned relative to the magnetic component; applying a magnetic field on the fluid and sorptive media in the container, where the magnetic component generates the magnetic field; reacting the fluid comprising constituents in the sorptive media and a magnetizable fluid loaded in the container positioned relative to the magnetic component; removing the magnetic field after reacting the fluid to release constituents of the fluid; filtering the separated constituents from the sorptive media and the magnetizable fluid; and releasing the separated constituents through an opening of the device that releases a fluid.

### BRIEF DESCRIPTION OF THE DRAWINGS

FIG. 1A is a perspective front view of a device configured in accordance with an embodiment of the present technology.

FIG. 1B is an isometric view of a device configured in accordance with an embodiment of the present technology, and FIG. 1C is an isometric cut-away view of the device of FIG. 1B.

FIG. 1D is an enlarged view of a magnetic plate used in the device of FIGS. 1B and 1C and configured in accordance with an embodiment of the present technology.

FIG. 2 is an isometric view of a device having a reservoir configured in accordance with an embodiment of the present technology.

FIGS. 3A and 3B are partially transparent isometric views of a device configured in accordance with another embodiment of the present technology.

FIG. 4A is a partially transparent isometric view of a device configured in accordance with a further embodiment of the present technology, and FIG. 4B is a partially transparent isometric view illustrating internal features of the device of FIG. 4A.

FIG. 5 is an isometric view of a system having a plurality of devices arranged in parallel in accordance with an embodiment of the present technology.

FIG. 6 is an isometric view of a system including a plurality of devices arranged in series in accordance with an embodiment of the present technology.

FIG. 7 is a partially transparent isometric view of a device configured in accordance with yet another embodiment of the present technology.

FIG. 8 is a partially transparent view of a device configured in accordance with a further embodiment of the present technology.

FIG. 9 is a partially transparent view of a device configured in accordance with another embodiment of the present technology.

FIG. 10 is a partially transparent view of a device configured in accordance with yet a further embodiment of the present technology.

FIG. 11 is a partially transparent view of a device configured in accordance with another embodiment of the present technology.

FIG. 12 is a partially transparent view of a device configured in accordance with a further embodiment of the present technology.

FIG. 13 is a partially transparent view of a device configured in accordance with a further embodiment of the present technology.

FIG. 14 is a partially transparent view of a device configured in accordance with another embodiment of the present technology.

FIG. 15 is a front end view of a member that enhances or improves distribution of fluid into the device.

### DETAILED DESCRIPTION OF THE INVENTION

The present disclosure is directed toward a device for treating, e.g., reacting, separating, filtering, or otherwise manipulating, compositions, and methods associated therewith. Several embodiments described below are discussed with reference to use in the context of a filtration or filter device comprising a container, a sorptive media, and a magnetic component for manipulating a magnetizable or polarizable fluid. The magnetizable or polarizable fluid may generally be used interchangeably here. The device may, for example, filter constituents from a sample, such as a liquid or a gas, by manipulating a magnetizable or polarizable fluid in the presence of a sorptive media, by using a magnetic component that is either part of the device or associated with the device, for manipulating the magnetizable fluid in the reaction chamber of the container portion of the device. Considering the applications discussed above, a sample to be treated may be of a known or unknown composition and percentage make up, and may originate as a solid, semi-solid, liquid, or gaseous mixture comprising individual constituents, which may be collected, separated, or reacted as desired. When the sample originates in a physical form, e.g., solid, that does not lend itself to direct manipulation by the device, it may first be converted into a semi-solid or fluid form. Thus, the illustrated device may be used for sampling substances, such as fluids, and for collecting, reacting, and separating constituents, such as for example, liquids, gases, airborne microorganisms, and volatile organic and inorganic compounds from a sample. The samples may be obtained from a variety of industries, such as for example, but not limited to, healthcare, agriculture, food, waste management, and landfill. Bakeries, breweries, calciners, ethanol plants, and fossil fueled power plants, as well as the atmosphere, which generate concentrated sources of, for example, carbon dioxide and one or more hydrogen donors such as various organic compounds, methane, and/or water, and may benefit from breaking down carbon dioxide and/or such hydrogen donor and recycling the products or constituents using the illustrated device (e.g. CO₂+3H₂→CH₃OH+H₂O and/or CO₂+C+4H₂→2CH₃OH).

Devices in accordance with the present invention may take any shape, such as, oval, ovoidal, circular, generally circular, round, square, rectangular, or modified versions of those or other applicable shapes. However, a generally cylindrical or a generally cylindrical and oval-type shape is preferred. As will be appreciated, the size of the device will largely depend upon the particular application for which it is to be employed. Devices of the invention may generally be referred to as containers or housings, where the containers contain reaction chambers or vessels. The containers will have one or more openings or inlets for introduction or entry of one or more fluids into a side and/or end of the container. The opening may comprise a channel for receiving or releasing a fluid. In another embodiment, the opening may comprise a first channel for receiving a fluid and the opening may comprise a second channel for releasing a fluid. The containers may also have one or more openings or outlets for releasing one or more fluids from a side and/or end of the housing or container. An opening may comprise a plurality of channels for receiving or releasing a fluid, where an opening may be one or more. In one embodiment, an opening may comprise a channel for receiving a fluid and the same opening may comprise a channel for releasing a fluid. Alternatively, a separator may divide the opening such that one side of the separator or channel receives a fluid and the other side of the separator or channel releases a fluid.

The device, as illustrated here, may include a container, canister, cartridge, or housing, all of which may be used interchangeably here. Regardless of whether constituents of the sample are desired for collecting, reacting, or separating, the device container in which the samples are placed may be composed of a variety of materials as appropriate for the samples and/or application. Since the process for reacting or separating some components may involve a reaction of some sort, the container may preferably be made of a material that is non-reactive; however, it is contemplated that the container material itself may provide an added benefit by assisting in a reaction.

One of ordinary skill in the art would understand how to select an appropriate container material that is preferably not only non-reactive, but one that could also be beneficial in various capacities such as providing expanded surface area, flow modification, and/or catalytic functions. For example, the container may be composed or made of, but not limited to, carbon fibers, graphene, glass fibers, ceramic fibers, and the like, or combinations thereof. The container may also be made from a polymer material, a transmissive material (e.g., glass), and/or other suitable filtration container materials. In various embodiments, the container may be a single integrated structure or unit. For example, the container may be made by compression molding polymer particles (e.g., polyfin particles made from recycled fluid containers) to form the container. In other embodiments, the container may be made by injection molding, extrusion, pultrusion, injection blow molding, thermoforming, spin forming, friction forming, and welding, or otherwise forming two or more pieces of the container, and subsequently joining the pieces together by gluing, welding, and/or using suitable fastening methods known in the art. As is commonly known and understood, certain functionalized carbon may be better inducers of an electric current or propagate electric current or magnetic charge, while certain composites of functionalized carbon and ceramic fibers are even better. However, graphene, such as multiple layers of graphene, is known to adsorb and potentially hold more material and serves as, for example, an excellent storage container in addition to providing synergistic functionalized benefits including, but not limited to exceptional electrical conductivity, ion and particle selectivity, catalytic properties, and heat transfer capabilities.

The container may also be configured to house a separator or divider that may extend a portion of or the entire length of the container. If one separator is utilized, it may preferably extend along the center line of the length of the body portion of the container to form two filtration channels. The filtration channels may be configured to run in parallel, while removing different contaminants from the incoming fluid. Alternatively, the parallel filtration channels may have fluid flow in opposite directions. In another embodiment, the separator itself may be a magnetic component, where the magnetic component may be permeable or solid and affixed to the container in such a manner that the magnetic component does not extend to the walls or sidewalls of the container, thereby allowing fluid flow to go around the magnetic component from a first filtration channel to a second filtration channel. The solid magnetic component may be affixed to the walls of the container with the use of arms that maintain a certain distance away from the walls. In another embodiment, multiple separators or dividers may be used creating multiple filtration channels, where the device may have one or more openings to receive a fluid and to release a fluid, or a plurality of channels for receiving or releasing a fluid, where some channels may receive a fluid while other channels may release a fluid. A further embodiment may be directed to a separator that may be a heat exchanger to transfer heat to or from the device, or to and from the device.

The illustrated device, magnetic fields, magnetic components, reaction type, and the sorptive media may be adjusted to filter a wide variety of samples, making the device adaptable to various waste streams. Waste may be defined as any material that is of no further use to an owner and is thus discarded. However, a lot of discarded waste may be recycled or reused. Waste may be classified as a solid, a liquid, or a gaseous form. Gaseous waste is normally sent into the atmosphere, either with or without treatment depending on the composition and regulations. Liquid waste is commonly discharged into sewers or bodies of water, again, with or without treatment. Solid waste is primarily disposed of in landfills because landfills are a simple, cheap, and cost-effective method of disposing solid waste. Landfills are also used for waste management purposes, such as for example, temporarily storing, consolidating, transferring, or processing waste materials.

However, landfills have many adverse impacts—pollution, off gassing, harboring disease vectors, and infrastructure damage along with hosting the loss of potentially valuable materials. For example, pollution may be in the form of contamination of groundwater, aquifers, and soil. Decaying organic waste found in landfills produces methane, carbon dioxide, and small amounts of nitrogen and oxygen, which may be released in the process known as off-gassing. Off gassing does not make efficient use of the generated gases, which ideally would be recycled for use in other applications. For example, landfill gases may be collected in wells or under polymer barriers. Landfill gas may be composed of constituents such as, methane, silane, sour gas (hydrogen sulfide—H₂S), carbon dioxide, and possibly even helium from thermogenic gas depending on the geological region from which the gas is derived. In one aspect of the invention, landfill gas constituents are preferably filtered through the described device to separate the various constituents for further processing or for recycling. For example, hydrogen sulfide may be reacted to breakdown into hydrogen and sulfur by electrolyzing hydrogen sulfide into hydrogen and sulfur. Alternatively, a chemical reaction may convert hydrogen sulfide to iron sulfide and hydrogen, where iron sulfide may be recycled as an agricultural nutrient. Carbon dioxide may be recycled as graphene or further converted into methanol.

Another example may be the processing steps required to remove impurities from natural raw gas before it may be used as a fuel. Natural gas may be used as an energy source for heating, cooking, generating electricity, fuel for vehicles, and as a chemical feedstock in the manufacture of plastics and other commercial organic chemicals. Natural raw gas is a hydrocarbon gas mixture of primarily methane, other higher alkanes, carbon dioxide, nitrogen, and hydrogen sulfide. Some of the by-products of processed natural raw gas include, but are not limited to, ethane, propane, butanes, pentanes, and higher molecular weight hydrocarbons; hydrogen sulfide (which may be converted into pure sulfur); carbon dioxide; water vapor; and sometimes helium and nitrogen. Instead of releasing helium, for example, into the general atmosphere or the burner of a gas stovetop, collecting helium for recycling is much more desirable. The illustrated device may process natural raw gas to remove the by-products for collection and easy storage.

A sample to be processed, e.g., treated, may be mixed with a magnetizable fluid prior to or during entry into the container, or after entry into the container of the device. For example, if a sample to be processed is mixed with a magnetizable fluid prior to entry into the container of the device, magnetic forces from a magnetic component that are part of the device or associated with the device may be used to induce a magnetic field and thereby draw the sample into the reaction chamber of the container. Alternatively, the sample and magnetizable fluid may be mechanically pumped into the container separately or in combination. Other forces, such as gravity or pressure gradients, may also be employed to introduce a sample and magnetizable fluid, separately or together, into the reaction chamber of the container.

The sample to be processed may be a fluid, where the term “fluid” is to be interpreted broadly throughout the specification and may include, for example, liquids, gases, plasmas, and/or solutions, some of which may include solid particles dispersed throughout the fluid. Fluid as described and used here may be understood to also include fluidized solids, and slurries, and may serve as a transporting agent, sampling agent, scrubbing reagent, pump, or reactive reagent. Additionally, several embodiments described here may be employed to filter or separate contaminants from a fluid. As explained, a device in accordance with the invention may be used to separate components, constituents, or elements from a composition or sample which may be combined with a magnetizable fluid. If otherwise not apparent from the description, the term “contaminant” or “constituent” may be employed and used interchangeably here, and which are intended to refer to any substance being removed from a fluid by, for example, the sorptive media.

In selected embodiments, the devices may be configured to remove different contaminants from the fluid or sample. For example, one of the devices may be configured to remove sulfur and another device may be configured to remove copper. The resultant purified fluid streams, therefore, each have different properties (e.g., a low sulfur fluid and a low copper fluid). In one embodiment, there may be a plurality of outlets or openings to separately capture the different purified fluid streams. Another embodiment is directed to one or more reservoirs for capturing or storing the different purified fluid streams.

In another embodiment, the fluid or sample may be a milieu of gases, such as for example, landfill gases containing methane (CH₄), silane (SiH₄), hydrogen sulfide (H₂S), also known as sour gas, and carbon dioxide (CO₂). Instead of off gassing the methane, for example, the illustrated device may adsorb methane and essentially subtract off the other gases. The other gases in the sample may be removed or separated from the methane by adsorptivity→specific functionality.

As discussed, one or more magnetic components or elements that induce, or are capable of inducing, a magnetic field within and/or across the housing of the device, may be part of, or associated with, the device. Thus, a magnetic component or element that is structurally part of the device, e.g., located within the reaction chamber, or in the body of the housing itself, or on the outside of the housing, may be composed of a material that either is magnetic or is magnetizable by an exterior force such as an electric charge, where a magnetic component or magnetic element may be used here to mean either a magnetic component or an element that may induce or generate a magnetic field. The magnetic element or component may be made from ferromagnetic materials, paramagnetic materials, and/or other magnetic materials. Some ferromagnetic materials, known to those in the art as “hard iron” materials, retain magnetization in the absence of an applied magnetic field, whereas paramagnetic materials, known as “soft iron” materials, are only magnetic in the presence of an externally applied magnetic field.

A magnetic element or component that is associated with the device may be located within a proximal distance to the housing such that its magnetic effect can be exerted upon the contents of the reaction chamber. As explained, the magnetic element or component may not be magnetic per se, but may be magnetizable, or may be at least partially magnetic and further magnetizable, by an external force such as an applied electric current or charge. Thus, while the magnetic elements may be of any material that is capable of generating a magnetic force or field such that the force or field will be exerted on a magnetizable fluid within the chamber, the magnetic elements may take the form of magnetic plates which may be positioned in parallel or perpendicularly with the flow of fluid within the chamber of the container. Alternatively, the magnetic components may make up part of the structure of the container in that the magnetic components may make up parts of the ends or sides of the container. Thus, they may be viewed as separate elements or components of the device that are in combination with the device, or they may be viewed as compositional materials that form at least a portion of the structure of the container, e.g., a wall, or an inside portion of a wall, or an outer portion of a wall of the container. Alternatively, the device may include magnetic components that form at least a portion of the structure of the container in combination with magnetic components that are also located within the reaction chamber of the housing.

Magnetic components located within the reaction chamber of the container may be adapted to allow the flow of fluid through the magnetic components. For example, when located within the reaction chamber, the magnetic components may be permeable or porous, e.g., possessing pores, so that they allow the passage of the fluid, which may be gas(es) or liquid(s), e.g., a magnetizable fluid and a sample, through pores, openings, holes, or interstices. Alternatively, the magnetic components may be secured or affixed, such as with arms, in positions that are generally opposing sidewalls inside of the container, and may be of such a size and shape that is less than the diameter of the interior of the reaction chamber, where the diameter may be the distance perpendicular to the flow of fluid, or width of the container, while the length of the container or body portion is the length, and the magnetic components do not extend to and touch the walls of the reaction chamber or container, thereby allowing the flow of fluid to go around the magnetic component or edges of the magnetic component. Another embodiment may be directed to a magnetic component which is positioned lengthwise. The fluid that enters the chamber may flow around the edges of the magnetic components into the sorptive media inside the reaction chamber, where the sorptive media may be positioned between the magnetic components to filter or process the sample into one or more constituents.

Preferably, the magnetic components are individually controllable such that the flow of the magnetizable fluid and sample into the reaction chamber of the container and/or through the reaction chamber of the container to exit the container of the device, may be adjusted by a source for controlling the magnetic elements, or control element. The flow of the sample may be controlled such that the sample slows or comes to a stop within the reaction chamber of the housing where it may undergo one or more reactions to adjust its composition. Thus, for example, when it is desired that a reaction occur in the reaction chamber of the container, the magnetizable fluid in combination with the sample may be arrested in the chamber of the container by applying a magnetic field, which essentially freezes the magnetizable fluid with the sample while the reaction occurs. If energy or activation is required for the reaction to occur, then that would be applied as well.

Constituents and particles immiscible with a magnetizable or polarizable fluid, such as for example, a ferrofluid may be captured in a magnetic field-induced ferrofluidic structure when subjected to a magnetic field. A permanent magnetic field, an induced magnetic field, or electromagnetic field (EMF) may be applied, either alone or in combination, to drive filtration of magnetizable or polarizable fluids and to separate contaminants or other substances from the magnetizable or polarizable fluid. Different types of magnetic components are contemplated for use with the device disclosed here. There may be at least one magnetic component that encompasses the body of the container. For example, the magnetic component may be in the form of a coil, which wraps around the container of the device. A coil wrapped around the container may be a coil wrapped partially around or around a portion of the body of the container, or alternatively, around the entire body of the container. In another embodiment, the magnetic component may be positioned inside, within or within the walls of, outside, around, or partially around the container, or the body of the container, or any combinations thereof sufficient to induce a magnetic field with or without an electromagnetic field. Alternatively, the magnetic component may be in the form of a coil, or any other shape that allows the passage of fluid from one side of the magnetic component to the other and/or through the length of the reaction chamber in the container. Any component or element that creates a magnetic field and allows the passage of fluid through the component or around the component is contemplated. As one of ordinary skill in the art understands, the component or element that may create a magnetic field must be within a sufficient distance from the magnetizable fluid with sample, such that the fluid would still be affected by the magnetic field. Non-limiting examples of forms of components that create a magnetic field include coils, plates, plates with holes, wire blankets, and the like, and combinations thereof.

Another embodiment may be directed to at least two magnetic components that are positioned at each of the proximal ends of the device container in a position that may be perpendicular to the flow of fluid, or alternatively, the magnetic components may be positioned along the length of the container in a position that is parallel to the flow of fluid. A further embodiment relates to more than two magnetic components that are positioned throughout the device container, where two magnetic components are positioned at each of the proximal ends of the device container and the other magnetic components are positioned in between the two proximal ends. Another embodiment may be directed to multiple magnetic components that are at each of the proximal ends of the device container, in between the proximal ends, and along the length of the of the container. In one embodiment the magnetic component may be a magnetic plate. In another embodiment, the magnetic plate may be a permanent magnet.

Another embodiment is directed to a magnetic plate that may be permeable, where the magnetic plate has a matrix of openings, apertures, or holes across the face of the magnetic plate. In yet another embodiment, the permeable magnetic plate has a plurality of magnets positioned in selected holes on the face of the magnetic plate. The individual magnets may be selectively arranged in the holes. Another embodiment may utilize the individual magnets to induce a magnetic field or fields.

One embodiment of the invention is directed to a device employing magnetizable or polarizable fluids, sorptive media, and a component that utilizes a magnetic field. The fields may be a magnetic field, an electromagnetic field, or both. For example, the magnetic component disclosed here may be, for example, a permanent magnet that creates a magnetic field without an electric field. In some embodiments of the invention, both a permanent magnet and an electromagnetic field (EMF) may be desired for controlling the flow of the fluid and/or magnetizable or polarizable fluid. Another embodiment is directed to printed circuits, which may be used to create or generate an EMF. A further embodiment comprises any component that may induce or generate a magnetic field, an EMF, or both. Moreover, the components may be individually or commonly regulated by a control element. For example, magnetic plates may be turned on by the control element to generate a magnetic field, and turned off to remove the magnetic field. In other embodiments, the control element may control the strength, the frequency, or both the strength and frequency of the magnetic field. Another embodiment may be directed to control elements for individually controlling each magnetic component or a single control element that controls all of the magnetic components. The component that induces or generates a magnetic field or EMF may have multiple benefits including, but not limited to, varying field strength; starting or stopping flow rates; providing heat exchange; convenience of use on either the interior or exterior of the container; and the like. In fact, a parabolic (or paraboloid or paraboloidal) reflectors (or dish or mirror) may be a type of component that induces or generates a magnetic field and/or EMF, and/or may also be used to collect or project energy such as light, sound, or radio waves for assisting in the progress or activation of a reaction in the reaction chamber of the container.

For example, the magnetic field produced by a coil may also magnetize any paramagnetic magnetic materials positioned on or in the fields of the magnetic components. In various embodiments, the ratio of ferromagnetic to paramagnetic materials may be manipulated to alter the strength and/or location of the magnetic field produced by the magnetic components. The magnetic field produced by the magnetic components may also be changed by manipulating the positions and orientations of the magnets. For example, changing the orientation of the magnets (e.g., rotating the magnets) may reorient or reverse the direction of the magnetic field.

Dielectrophoretic (or DEP) applications may also be employed in accordance with the present inventions. Dielectrophoresis is a phenomenon wherein a force is exerted on a dielectric particle when it is subjected to a non-uniform electric field. All particles exhibit dielectrophoretic activity in the presence of electric fields. However, the strength of the force depends upon various factors, including the medium, the particles' electrical properties, the particles' shape and size, and the frequency of the electric field. Consequently, fields of a particular frequency can manipulate particles with great selectivity.

Dielectrophoresis has many medical applications. For example, biological cells have dielectric properties. Therefore, in another embodiment of the invention, the treating device may be employed in the separation of cells, or the orientation and manipulation of nanoparticles and nanowires. Furthermore, a study of the change in DEP force as a function of frequency can allow the electrical (or electrophysiological in the case of cells) properties of the particle to be elucidated. Thus, in certain embodiments, the device may be employed in biomedical sciences areas, such as medical diagnostics, drug discovery, cell therapeutics, and particle filtration.

The devices of the invention may employ, for example, magnetizable and/or polarizable fluids. As used here, the term “magnetizable or polarizable fluids” refers to fluids that become magnetized or polarized, respectively, in the presence of a magnetic field. Depending on the particular application, examples of such fluids may include magnetic microspheres, magnetic nanospheres, and ferrofluids, which may regulate, direct, or control the flow of a fluid. The magnetic nanoparticles will normally be suspended in liquids such as oil, water, or alcohol. Travelling magnetic fields may be employed to manipulate the magnetizable fluids, and thereby cause the very fast pumping of the fluids through a device according to the invention.

Such magnetizable fluids may also be employed in various biomedical applications such as diagnostics, drug targeting, molecular biology, cell isolation, purification, radio immunoassay, hyperthermia causing agents for cancer therapy, and nucleic acid purification. See, for example, Timko et al., Application of magnetizable complex systems in biomedicine, Czechoslovak Journal of Physics, vol. 54 (2004), Suppl. D. In, for example, biological applications, magnetizable microspheres based on, for example, organopolysiloxane, may also be employed. Biocompatible magnetizable or polarizable fluids may use water as a carrier medium, and such fluids may be stabilized by ionic interaction with a bilayer of, for example, acid, or aspartate and glutamic acids, or peptides. Various biopolymers, such as dextran, polyethylene glycol or polyvinyl alcohol, may also be employed. Applications using such biocompatible magnetizable fluids may include, for example, isolation of cells, proteins and, in particular, enzymes.

Another embodiment may be directed to a device in accordance with the present invention, where the device may receive a sample of a body fluid, such as blood (whole or separated portions thereof) and, based on the different magnetic or electrophoretic forces that are exerted on or applied to different particles in the sample, indigenous, or foreign (e.g., a virus, bacteria, nonindigenous cell such as cancer cell, or a matter such as a contaminant or pollutant), components of a body fluid sample may be separated as described in accordance with the processes of the invention.

In one embodiment, the magnetizable or polarizable fluid may be a ferrofluid. The properties of ferrofluids have been studied such as by Zahn et al., “Magnetizable fluid behaviour with effective positive, zero or negative dynamic viscosity,” Indian Journal of Engineering & Materials Sciences, Vol. 5, December 1998, pp. 400-410. Briefly, ferrofluids are colloidal liquids made of ferromagnetic or ferrimagnetic particles or nanoparticles, suspended in a carrier fluid, such as for example, an organic solvent or water.

Each individual particle of a ferrofluid may be coated with a surfactant to avoid clumping or aggregation. Since ferrofluids do not usually retain magnetization in the absence of a magnetic field, they are classified as superparamagnets, where their magnetic moments tend to align along the applied field resulting in a net magnetization. Whereas, ferromagnets, such as for example, iron, nickel, cobalt, and some of the rare earth metals (i.e., gadolinium, dysprosium, and samarium and neodymium in alloys with cobalt) exhibit a unique magnetic behavior which enables the ferromagnets to stay magnetized for a period of time after being subjected to an external magnetic field. Thus, ferrofluids may lock up or freeze a gradient containing a sample upon application of a magnetic field.

The ferrofluid suspended with surfactant-coated magnetic particles, such as for example, iron, may exert forces on the fluid in which they are suspended and essentially behave as a magnetic liquid. Non-limiting examples of surfactants used to coat the nanoparticles suspended in a liquid include: oleic acid, tetramethylammonium hydroxide, citric acid, and soy lecithin. These surfactants prevent the aggregation of the nanoparticles thereby prohibiting them from becoming too heavy to be held in suspension by Brownian motion. Preferably, the magnetic particles in an ideal ferrofluid will not settle or separate, even when exposed to a strong magnetic or gravitational field. Instead, the ferrofluid may form ferrofluidic structures upon application of a magnetic field, where the desired constituents or particles of interest are captured, frozen, or locked up until the magnetic field is released.

The device also employs a sorptive filter media, sorption media, or filter media, all of which are used interchangeably here, which may include, but are not limited to, activated carbon, zeolites, graphene, boron, polyacrylonitrile (PAN; (C₃H₃N)ₙ), borosilicate glass, spinel, clay such as calcines, sand, mica, ceramics, other natural or manmade materials, other suitable filtration substances, other medical grade filtration substances, and the like, or combinations thereof. The filter media may be useful for filtering contaminants in the healthcare industry, such as for example, microorganisms, bacteria, and viruses, from samples that are required to be sterile. For example, a blood sample may be filtered or screened to remove contaminants that may infect or harm a mammal. Another embodiment may be to filter blood samples to separate various cells or cell types from the sample. For example, plasma, platelets, red blood cells, white blood cells, blood factors, proteins, or enzymes may be separated by the filter media. Medical grade saline, water, or oxygen may also be filtered by the filter media contemplated for use in an embodiment of the illustrated device. Moreover, many drugs should be filtered since they may precipitate, form granular or flaky deposits, crystallize, form insoluble polymeric derivatives, or form gelatinous fibers. Drugs, such as for example, amiodarone, anti-thymocyte globulin (ATG), mannitol (C₆H₈(OH)₆), thiotepa (N,N′N′-triethylenethiophosphoramide), and asparaginase, may be filtered to remove precipitates and the like, but also other contaminants (e.g., bacteria, microbes, viruses) from the drugs.

Essentially the sorptive filter media may comprise parallel layers, partitions, or zones of a sorptive material that may be spaced apart by a particular distance or varying distances, either by separate physical entities or the layers of the sorptive media have differing properties which in essence form different layers, all of which may be within the reaction chamber of the device container. For example, activated carbon may control the spacing of layers of graphites or graphene. A sample initially may be presented at an edge of the sorptive filter media. The edge of the filter media affords access to regions between layers of the sorptive media. Heat may be transferred away from the sorptive media to facilitate or prompt the media to load (i.e. absorb and/or adsorb) molecules of the sample into the sorptive media. Similarly, a voltage of a first polarity may be applied to the sorptive media to facilitate or prompt the sorptive media to load molecules of the sample. Analogously, when the sorptive media is exposed to a pressure that may be increased to facilitate or prompt the sorptive media to load molecules of the sample. In some embodiments, the sorptive media also comprise surface structures that load the sample. In further embodiments, a catalyst facilitates the loading of a substance into the sorptive media. A sample may be unloaded from the sorptive media by transferring heat to the sorptive media, applying a voltage of an opposite polarity than the first polarity to the sorptive media, or by reducing pressure applied to the sorptive media. The sorptive filter media essentially acts as a magnetic fluidized bed media. The device may have a cavity, such as the reaction chamber, within the container that includes and/or is loaded with a sorptive media through which the magnetizable or polarizable fluid may be filtered. The sorptive media may be introduced into the cavity or reaction chamber before filtration, during filtration (e.g., in conjunction with the magnetizable or polarizable fluid), or both before and during filtration. For example, the cavity may be pre-loaded with any of the described sorptive media or combinations thereof. The contaminants or constituents of interest in a sample may be separated in the sorptive media and magnetizable or polarizable fluid by any number of properties, including, but not limited to, size, density, charge, magnetic properties, flow speed, and the like, or combinations thereof.

In various embodiments, the cavity or reaction chamber of the housing or container may be loaded with an architectural construct. Architectural constructs are synthetic matrix characterizations of crystals that are primarily comprised of graphene, graphite, boron nitride, and/or another suitable crystal or constituent. The configuration and the treatment of these crystals heavily influence the properties that the architectural construct will exhibit under certain conditions. For example, architectural constructs may be manipulated to obtain the requisite geometry, orientation, and surface tension to load (e.g., adsorb) almost any element or soluble substance. Accordingly, the architectural construct may be configured to load a predetermined substance sample (e.g., sulfur or a compound containing sulfur such as iron or hydrogen sulfide) introduced into the cavity in a non-fixed state, and selectively filter and/or chemically bind (e.g. form a compound or otherwise reside on or within the surface of ferromagnetic particles) to isolate the predetermined substance and remove it from the fluid. In other embodiments, the architectural construct may be introduced into the system as the fluid enters the device. Additional features and characteristics of architectural constructs are described in U.S. Publication No. 20110206915 (U.S. patent application Ser. No. 13/027,214, filed Feb. 14, 2011, and entitled “ARCHITECTURAL CONSTRUCT HAVING FOR EXAMPLE A PLURALITY OF ARCHITECTURAL CRYSTALS”) and U.S. Publication No. ______ (U.S. patent application Ser. No. ______, filed Aug. 13, 2012, and entitled “ARCHITECTURAL CONSTRUCT HAVING FOR EXAMPLE A PLURALITY OF ARCHITECTURAL CRYSTALS”), each of which is incorporated herein by reference in their entirety.

In other embodiments, an architectural construct may be configured as a substrate made from a sorptive filter media that comprises parallel layers of a sorption material spaced apart from one another by a certain distance or varying distances. A substance may be presented at an edge of the substrate where the sorptive media provides access to zones, partitions, or layers of the sorptive media. Heat may be transferred away from the sorptive media to facilitate and/or cause the sorptive media to load (i.e. absorb and/or adsorb) molecules of the substance into the sorptive media. In other embodiments, a voltage of a first polarity may be applied to the sorptive media to facilitate and/or cause the sorptive media to load molecules of the substance. In further embodiments, a pressure experienced by the sorptive media may be increased to facilitate and/or cause the sorptive media to load molecules of the substance. The sorptive media may also include surface structures that load the substance and/or catalysts that facilitate the loading of a substance into the sorptive media. A substance may be unloaded from the sorptive media by transferring heat to the sorptive media, applying a voltage of an opposite polarity than the first polarity to the sorptive media, and/or by reducing a pressure experienced by the sorptive media. Additional features and ways of manipulating architectural constructs with sorptive media or sorptive substrates are described in U.S. Publication No. 20110041519 (U.S. patent application Ser. No. 12/857,515, filed Aug. 16, 2010, and entitled “APPARATUSES AND METHODS FOR STORING AND/OR FILTERING A SUBSTANCE”), which is incorporated herein by reference in its entirety.

In exemplary embodiments, the device may use the sorptive media (with or as, for example, an architectural construct) to filter sulfur from a fluid (e.g., natural gas). The architectural construct may first be loaded with iron, iron carbide, various compounds of halogens and iron, and/or other substances or elements that have an affinity to sulfur, and then introduced into the device (before or during filtration or processing). When the sulfur-laden fluid flows through the loaded architectural construct, the sulfur separates from the fluid to join with, for example, the iron to form iron sulfide.

The architectural constructs and/or other sorptive media in the cavity or reaction chamber of the container may be configured to selectively remove substances from the magnetizable or polarizable fluid as it passes through the device. For example, an architectural construct may be configured to remove sulfur from natural gas or renewable fuels. The magnetic fields generated by the magnetic components and/or the coil may drive the magnetizable or polarizable fluid through the cavity and, in various embodiments, change the characteristics of the magnetizable or polarizable fluid such that certain substances are allowed to pass through the cavity while others are trapped by the filter media. Accordingly, the device allows for numerous variables (e.g., strength and direction of magnetic field, configuration of sorptive media, etc.) to be manipulated such that a wide variety of substances may be filtered from the magnetizable or polarizable fluid, and is therefore highly adaptable to various systems. When the sorptive media becomes exhausted (e.g., fully loaded), the filtered sample or constituents of the sample may be removed from the device. For example, if the sorptive media is loaded with alcohol, water may be flushed through the device to unload the alcohol. In other embodiments, the sorptive media may be flushed with other fluids to remove the loaded substance, or the loaded filter media may be disposed and replaced with a new sorptive media. In various embodiments, the loaded substance may be harvested from the sorptive media.

Another embodiment is directed to the reactions that may occur in the container of the device, or more specifically, in the reaction chamber of the container. Some reactions may require an activating element that may initiate, activate, or catalyze a reaction to yield constituents from a fluid. The activating element may also assist in the progression of or termination of a reaction. One of ordinary skill in the art would understand whether an activating element may be needed for the particular reaction needed to result in the desired constituent. If the desired reaction requires heat, i.e., is an endothermic reaction, heat or light energy may be introduced by an activating element into the reaction chamber. For example, activating elements of the container, such as for example, light elements, including but not limited to, infrared or ultraviolet light elements, may be located within the reaction chamber, or may comprise at least a portion of the housing walls of the reaction chamber, e.g., may be the container walls themselves, or may be situated in a portion of a container wall to direct light energy into the reaction chamber and thereby assist in the progression or activation of the reaction. Alternatively, the container may comprise a jacket, a channel, or a plurality of activating elements, associated externally or internally with one or more of the container walls, or may have pathways or channels within one or more of the container walls, that would allow for the application of an activating element, such as heat by, for example, the introduction of a hot liquid or liquid that could be made to produce heat, through the jacket or channels. The activating element may be in the form of, for example, a heat exchanger.

Conversely, if the desired reaction produces heat, i.e., is an exothermic reaction, the activating element may be a cooling element, or a heat exchanger that removes or withdraws heat, and may be located within the reaction chamber, or may comprise at least a portion of the housing walls of the reaction chamber, e.g., may be the housing walls themselves, or may be situated in a portion of a housing wall to withdraw heat from the reaction in the reaction chamber. Thereby, the cooling element may assist in the progress of the reaction and/or produce valuable heat energy that may be employed for other purposes or other reactions in devices associated with the device hosting an exothermic reaction, e.g., in a series of devices in accordance with the invention. One device may carry out an exothermic reaction and another may carry out an endothermic reaction, where the valuable heat energy derived from the device hosting the exothermic reaction may be employed to assist in a device hosting an endothermic reaction.

The endothermic and exothermic reactions which require or produce heat may be achieved using the heat transfer device or more generally the activating element. However, in addition to thermal energy, chemical, mechanical, electrical, ultrasonic, optical activation, or the addition of catalysts, or combinations thereof, may drive reactions to yield desired constituents of a fluid. The activating element of the container may be any element that initiates, assists in the progression of or assists in the termination of a reaction, where the reaction is activated thermally, chemically, mechanically, electrically, ultrasonically, optically, or by the addition of a catalyst, or any of the combinations in an embodiment where more than one reaction may occur in the reaction chamber or reaction chambers of the device. For example, an activating element may utilize electrolysis to assist in the reaction of electrolyzing hydrogen sulfide (H₂S) to form hydrogen (H₂) and sulfur (S). Another embodiment may be directed to optical energy by applying ultraviolet (UV) or infrared (IR) sources to change the fluid flow when used in association with for example, magnetic fields. Halogenation of hydrocarbons may occur under UV light. For example, saturated hydrocarbons or alkanes can react with halogens in the presence of UV light. During this reaction, halogen atoms substitute for hydrogen atoms, one at a time, producing a haloalkane and a hydrogen halide. An exemplary reaction may be: ethane (C₂H₆) and bromine water (Br₂) in the presence of UV light reacts to result in the formation of bromoethane (C₂H₅Br) and hydrogen bromide HBr. However, unsaturated hydrocarbons, such as for example alkenes and alkynes, readily undergo addition reactions with halogens, even without the presence of UV light. For example, ethene (C₂H₄) and bromine water (Br₂) reacts to break the double bond to form 1,2-dibromoethane (C₂H₄Br₂). Another process that may be practiced is the ultrasonic driven dissociation of sorbed or water born carbon dioxide (CO₂) into carbon (C) and oxygen (O₂). When this is practiced with copper production in which the copper serves as a catalyst, a very high conversion efficiency for converting carbon dioxide (CO₂) into carbon (C) and oxygen (O₂) may be provided for the ultrasonic energy conversion to potential chemical energy. Advantages of this particular process with respect to the illustrated device, may include the separation of the solid forms of carbon and copper, which are readily processed to other outcomes as is the separated oxygen. In another exemplary illustration of carbon dioxide dissociation of methanol (CH₃OH liquid), carbon monoxide (CO) and ½ oxygen (O₂) may be produced and separated. A parallel process of dissociating methane (CH₄) produces and separates carbon (C) and 2 hydrogens (H₂). The carbon monoxide produced in one reaction and the hydrogen produced in the parallel reaction results in the formation of methanol, which may be recycled. In another embodiment, a pressurized reaction of carbon dioxide (CO₂) and 3 hydrogen (2 H₂) yields methanol (CH₃OH) and water (H₂O). The water may be separated as a condensate by differential condensation. Another embodiment utilizes a catalyst, such as for example, copper-zeolites, platinum catalysts, nickel catalysts, and the like, to convert methane to methanol which may then be recycled. A further embodiment may react steam (H₂O) and methane to produce carbon monoxide (CO) and 3 hydrogens (3H₂), where the carbon monoxide may be further reacted with H₂O to form carbon dioxide (CO₂) and hydrogen, where the carbon dioxide may be further reacted with 2 hydrogens (2H₂) to yield methanol (CH₃OH).

In another embodiment, the composition or fluid from which constituents are desirably separated may be landfill gas, where landfill gas comprises methane, hydrogen sulfide, carbon dioxide, and silane. Each of these constituents may be recycled or further broken down for recycling. For example, methane may undergo chemical activation, specifically hydrolysis, which yields carbon monoxide and hydrogen, where the carbon monoxide may further undergo hydrolysis to yield carbon dioxide and hydrogen, and the carbon dioxide undergoes another chemical reaction, specifically hydrogenation, to yield methanol which may be recycled. Hydrogen sulfide may undergo electrical activation to yield hydrogen and sulfur. Carbon dioxide may undergo ultrasonic activation to yield carbon and oxygen. By subtractive filtration, all of the constituents from landfill gas may be removed, for example, to leave as a final constituent silane. Silanes may be useful as a material for a variety of applications. For example, but not limited to, silanes may function as crosslinking agents, adhesion promoters, coupling agents, and water scavengers. In addition to silanes, the other separated constituents may be useful individually, for example, carbon dioxide may be recycled as graphene, or may be further converted to methanol. Sulfur may preferably be heated with iron to form iron sulfide which may be useful in the agricultural industry.

Generally speaking, a reduction in capillary action may encourage the removal of filtrate through the sorptive media. The sorptive media may form conduits or channels which create suction—essentially pulling the sample or portions of the sample—through capillary action from where the sample entered the device, through the body of the container, and to the outlet. Subtraction of various constituents of the sample may occur by controlling the capillary action. For example, if the sample is a milieu of gases (A, B, and C), capillary action may subtract out the various gas constituents in stages: ABC→A→BC→B→C, where A is adsorbed, yielding BC, then adsorbing B, yielding C. Alternatively, the subtraction occurs as follows: ABC→AB→C→B→A, where AB is differentially adsorbed to yield C, then A is adsorbed to yield B, and finally A is released or collected.

The differential magnetic catch and release (DMCR) technique has also been used as a method for the purification and separation of magnetic nanoparticles. DMCR separates nanoparticles in the mobile phase by magnetic trapping of magnetic nanoparticles against the wall of an open tubular capillary wrapped between two spaced apart electromagnetic poles. Capillary action is the ability of a liquid to flow in narrow spaces without the assistance of, and in opposition to, external forces like gravity. The effect may occur in porous materials and in some non-porous materials such as liquefied carbon fiber.

In an embodiment directed to the operation, a fluid may enter or be drawn or pumped into the reaction chamber of the housing. The fluid may contain a variety of constituents that are desirably separated out and recycled or further processed. The fluid, which may contain, for example, mixed landfill gases, such as, sulfur-containing compounds, for example, H₂S, sour gas constituents, sulfides, and various other thio compounds; silanes; methane; gaseous silica; organosilicon; carbon dioxide; and which may have been combined with the magnetizable fluid prior to, during, or after its entry into the reaction chamber of the housing, will then be subjected to the action of a magnetic force of one or more of the magnetic components contained, for example, within the container. The fluid may be magnetically drawn through the sorptive media, which may be provided in one or more layers or zones within the housing. The sorptive media may then filter the fluid and separate the constituents of the fluid based upon, for example, capillary gradients, density gradients, size gradients, or electrochemical gradients, where different capillary gradients may separate different constituents of the fluid based upon the respective size of the constituents of the fluid such that smaller constituents are drawn to a magnetic movement of a ferrofluid while larger components are arrested in a different part of the sorptive media. A density gradient is a spatial variation in density over an area, for example in the sorptive media over the length of the reaction chamber. Whereas, electrochemical gradients utilize electrical and chemical forces to move ions across a membrane. Specifically, the electrical component may be affected by a difference in charge across a membrane, while the chemical component may be affected by a difference in concentration of ions across the membrane. Once each of the constituents are separated, simultaneously, or afterwards, reactions among the constituents may be initiated, e.g., energy may be applied to activate a reaction, to break down H₂S to hydrogen and sulfide gas; break down methane into carbon and hydrogen gas; or break down carbon dioxide into carbon and oxygen gas, in the sorptive media, or different zones of the sorptive media. Under the influence of a magnetic field, a reaction chamber, or chambers depending on the number of magnetic components associated with the device, comprising the magnetizable fluid situated in between the magnetic components may be held or locked up as a matter of density, i.e., the particles of the magnetizable fluid become the dense media as if they form a solid. There may be different locations or zones of chemical densities where the reactions are run.

Alternatively, the sorptive media may be of such a size and quality as to separate one of the constituents from the fluid and allow the remaining constituents to pass through one or more of the outlets, or openings for releasing constituents, of the container of a device and into a second, third, and/or fourth, etc., device, for individual separation of each of the components from, for example, a landfill gas mixture. Hence, two or more devices may be connected in series or parallel to allow for the separation of various constituents from a sample fluid at different points, or a single device may allow for separation of one or more constituents from a sample fluid, based upon the sorptive media employed within the device, and then allow for the release of each of those separated constituents through one or more outlets, or openings for releasing constituents, in the container of a single device.

Once the desired reaction is or reactions are complete, for example where a sorptive media traps one constituent of a landfill gas mixture, and allows the remaining constituents to move on or pass through to one or more other devices of the invention for further breakdown of the remaining constituents of the landfill gas composition into its respective constituents, and further breakdown of the respective constituents into their elemental bases, the reaction products of the first reaction, for example the breakdown of H₂S into hydrogen and sulfur gas, may then be released from the device where the breakdown reaction initially occurred to separate the elemental gases. By having two or more magnetic components in a container, a sample fluids' constituents in mixture with the magnetizable fluid may be manipulated or moved to various areas within the container of a device and caused to move through one or more types of sorptive media, thereby separating the constituents of the fluid from each other.

In one embodiment regarding the operation, a fluid may be introduced into the device via one of the openings. The magnetic field induced by magnetic components, for example, a coil, and concentrated or generated by the magnetic components, may interact with a magnetizable or polarizable fluid, which may be a ferrofluid (e.g., such that the ferrofluid assumes a structure under the magnetic field) to drive the fluid and ferrofluid through the device. In instances where the sample fluid being filtered is not inherently a ferrofluid (e.g., water, alcohol, glycerin, etc.), the fluid may be pre-treated and loaded with ferromagnetic or iron particles such that it takes on the properties of a ferrofluid and may be used with the device. In various aspects of the technology, the magnetic fields provided by the coil and/or the magnetic components may be manipulated (e.g., by changing the current magnitude or direction, frequency of application, orientation of the magnets in the magnetic components), or combinations thereof, to alter the flow rate of the magnetizable or polarizable fluid through the device. The magnetic fields may therefore provide flow impetus or valving (“magnetic valving”) of the sorptive media within the container. The magnetic fields may also be manipulated to change properties or characteristics (e.g., viscosity) of the ferrofluid being filtered, and therefore may change the sample constituents filtered from the ferrofluid. Accordingly, the magnetic fields created by the device may be used both to treat the fluid sample and drive filtration (i.e., load and unload the device with the magnetizable or polarizable fluid).

In various aspects of the present technology, the device may be manipulated to control the size of the precipitate (i.e., the filtered substance or sample). For example, the dwell time of the fluid may be changed by manipulating the magnetic components to slow the flow rate of the fluid through the device. Additionally, the temperature, pressure, and/or other characteristics of the device may be modified to create a certain collection or precipitate size. In selected embodiments, for example, carbonyls may be used to generate iron of a specific particle size and shape.

The device may also be used to harvest various constituents, such as copper from copper sulfide. For example, a copper-containing mixture, such as a fluid mixture, may be collected in a reservoir or in the device itself, and iron or an iron-containing composition may be added to the copper-containing fluid to create a magnetizable or polarizable fluid mixture. If collected in a reservoir, the copper/iron mixture may be introduced into the device. As the copper/iron mixture flows through the device, the iron is affected by the applied magnetic field while the copper is not. The addition of energy from any appropriate source makes the sulfide more stable. This separates the iron from the copper, and allows the copper to exit the device and be harvested in its pure state, while the iron may be stabilized by the production of iron sulfide and remains in the sorptive media of the reaction chamber until further filtered or separated using similar techniques, or removed for storage.

In various aspects of the present technology, the device may also be used in conjunction with sensor systems. For example, the device may selectively filter a substance from a fluid, measure the level of that substance with respect to the fluid, and indicate when the level of the substance is above a pre-determined threshold. In one embodiment, the device may be positioned proximate a fitting in a passageway to sense and/or predict when a leak occurs. A further embodiment is directed to a device comprising sensors or a means for testing the filtered sample or constituents of the sample. In another embodiment, a sensor or plurality of sensors may be positioned in the reaction vessel of the container of the device, where the sensors are not affected by or affect the reaction, magnetizable fluid, and/or sorptive media. By placement within the reaction vessel, the location of the various constituents within the reaction vessel may be detected, and possibly, depending on the property that the sensor may detect, the identity of the constituent may be determined. Having knowledge of the location of each of the constituents may be advantageously helpful when valving and releasing the constituents. Non-limiting examples of features that may be tested include pH, optics such as refractive index, electric conductivity, thermal properties such as the specific heat of gases, and the like, or combinations thereof. For example, the device may be used in conjunction with the sensor systems described in U.S. Pat. No. 8,441,361 (U.S. patent application Ser. No. 12/806,634, filed Aug. 16, 2010, entitled “METHODS AND APPARATUSES FOR DETECTION OF PROPERTIES OF FLUID CONVEYANCE SYSTEMS”), which is incorporated herein by reference in its entirety.

In various embodiments, one or both of the end portions of the container may include a fluid distribution element for enhancing the flow or distribution of fluid into the device. The fluid distribution element may be or comprise, for example, fluid distribution channels (e.g., staggered spiral-shaped channels) that spread the fluid evenly or substantially evenly across the diameter or face of the magnetic components, the sorptive media, the container, and through the length of the cavity or body of the container, or combinations thereof. This reduces overuse of the sorptive media at the center portion of the cavity and increases the surface area of the sorptive media that participates in the processing described here. In some embodiments, the fluid distribution channels may also include a filter media to provide additional filtration to the system. For example, the distribution channels may be made from a spiraled filter media described in U.S. Publication No. (U.S. patent application Ser. No. ______, filed Aug. 13, 2012, and entitled “FLUID DISTRIBUTION FILTERS HAVING SPIRAL FILTER MEDIA AND ASSOCIATED SYSTEMS AND METHODS”), which is incorporated by reference herein in its entirety. In other embodiments, the body portion of the container may include the fluid distribution channels to distribute fluid across and enhance the flow through the cavity.

Another embodiment of the invention is directed to the use of the illustrated device for purifying salt water into potable water or separating minerals from brackish water. The container of the device may have one or more chambers for filtering a fluid. In one embodiment, the container may have a first chamber and a second chamber, and optionally a third chamber, where the first chamber may preferably be made of sorptive media, such as for example, graphene which is one atom or a few atoms thick, the second chamber may surround, either completely or partially, the first chamber. The second chamber may act as a collection sleeve, where, for example, if salt or brackish water is being purified, the purified water may be collected and/or filtered into the second chamber, and the third chamber may surround, either completely or partially, the second chamber and may be an outer shell of the container or the wall of the container. A fluid distribution element comprising a spiral conduit may have fluid distribution channels, which may take the shape of a cap-like structure. The fluid distribution element may be placed at the opening of the device at one end portion, where the fluid may be introduced to the container through the fluid distribution element. The fluid distribution element may distribute a fluid evenly or substantially across the entire fluid flow pathway which may span the width of the container by first entering through the width or diameter of the opening of the container. The fluid distribution element may have a diameter equal to, about equal to, or of the diameter of the opening of the container, or alternatively, the diameter of the fluid distribution element may have a diameter of less than the diameter of the opening of the container. The spiral conduit may have an opened face and an opposite closed face. For example, the opened face surface may be a concave surface that curves inward, while the opposite closed face, may be a convex surface that bulges outward. Alternatively, the opened and closed faces may not be curved, rather they may be generally vertical or straight. An inlet or opening for receiving fluids may be positioned on the closed face side, where the fluid, for example, salt water or brackish water, enters. The salt water or brackish water fluid spirals around the conduit or fluid distribution channels allowing for some of the fluid to expel from the opened face towards the magnetic component while some of the water continues spiraling around the fluid distribution channels. The spiral conduit or fluid distribution element spreads the fluid evenly or substantially evenly across the cross section of the sorptive media and/or magnetic component or magnetic filter component, which may be placed behind the fluid distribution element, i.e., between the second end portion or opening and the fluid distribution element, where, advantageously, the impedance along the magnetic component is spread throughout the width of the container, as well as over the entire face of the magnetic component, or generally across the width of the container or generally over the entire face of the magnetic component, and not only focused in a direct linear fashion from where the inlet extends. As the salt water, for example, follows the helical or spiral path of the fluid distribution channels, the sodium chloride increases in pressure while the water pressure decreases. As a result, the water may then filter through the first chamber into the collection sleeve or second chamber, while the sodium chloride or solute continues flowing through the length of the container during this solute separation and exits at the outlet or opening that releases a constituent, constituents, or fluid at the opposite end of the container from the inlet.

Reference throughout this specification to “one embodiment” or “an embodiment” means that a particular feature, structure, or characteristic described in connection with the embodiment is included in at least one embodiment of the present disclosure. Thus, the occurrences of the phrases “in one embodiment” or “in an embodiment” in various places throughout this specification are not necessarily all referring to the same embodiment. Furthermore, the particular features, structures, or characteristics described with reference to a particular embodiment may be combined in any suitable manner in one or more other embodiments. Moreover, the headings provided herein are for convenience only and do not interpret the scope or meaning of the claimed disclosure.

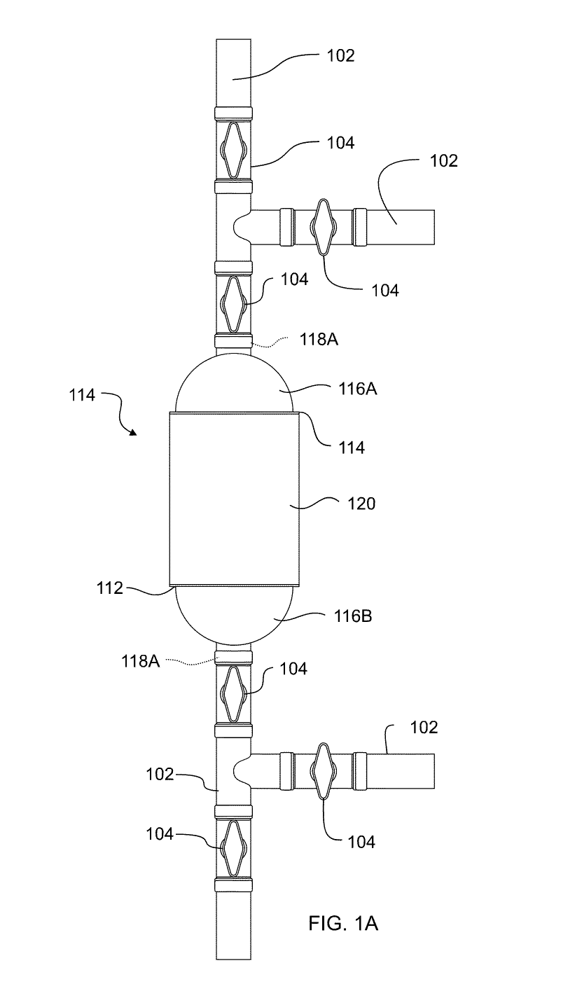

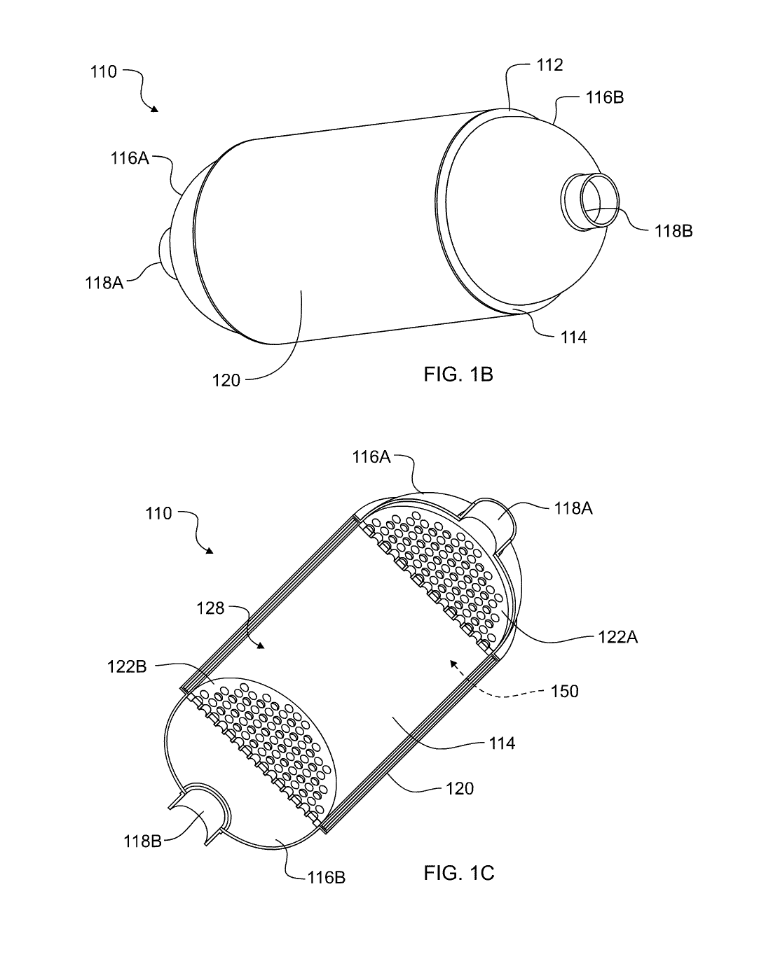

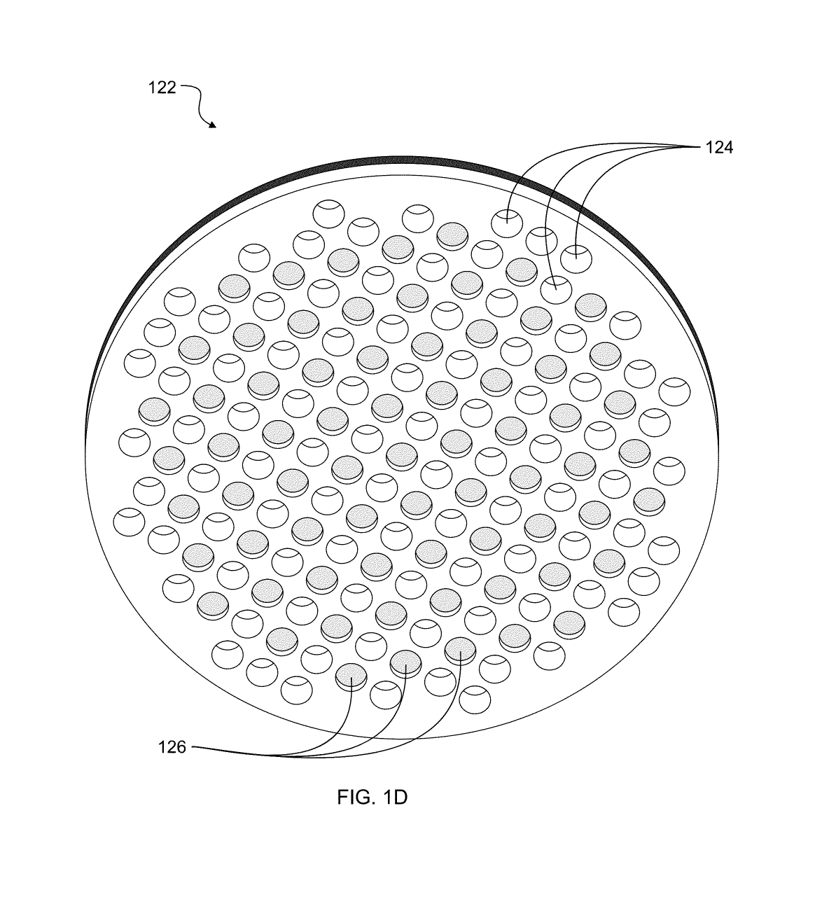

Certain details are set forth in the following description and in FIGS. 1-15 to provide a thorough understanding of various embodiments of the disclosure. However, other details describing well-known structures and systems often associated with devices, such as filters, filter media, and/or other aspects of devices, are not set forth below to avoid unnecessarily obscuring the description of various embodiments of the disclosure. Thus, it will be appreciated that several of the details set forth below are provided to describe the following embodiments in a manner sufficient to enable a person skilled in the relevant art to make and use the disclosed embodiments. Several of the details and advantages described below, however, may not be necessary to practice certain embodiments of the disclosure

FIG. 1A is a perspective front view of a device 110 configured in accordance with an embodiment of the present technology, and FIGS. 1B and 1C are isometric and isometric cut-away views, respectively, of the device 110 of FIG. 1A. Referring first to FIG. 1A, the device 110 may include one or more passageways 102 (e.g., tubing, piping, etc.) that feed an unfiltered fluid sample to the device 110 and transfer a filtered fluid away from the device 110. The passageways 102 may be made from materials that are suitable for transporting fluids, such as plastics (e.g., PE, PP, PTFE, PFA, CPVC, PVC), metals (e.g., copper), and/or other suitable plumbing materials. Valves 104 may be positioned on or in the passageways 102 to regulate fluid flow to, from, and through the device 110 and direct fluid toward and away from the device 110. The valves 104 may be any of a number of conventional fluid regulation valves, such as ball valves, gate valves, check valves, pinch valves, etc.

Referring to FIG. 1C, one embodiment of the device 110 may include an insulated conductor coil 120 (e.g., a solenoid) positioned proximate (e.g., in or around) an outer surface of the container 112. In the illustrated embodiment, the coil 120 extends along the length of the container's body portion 114. However, in other embodiments the coil 120 may be positioned along shorter or longer portions of the body portion 114 and/or on other portions of the device 110. The coil 120 may be formed around a metallic core (e.g., an iron alloy core) and configured to carry an electric current such that the coil 120 forms an electromagnetic field (EMF) across at least a portion of the device 110. As further shown in FIG. 1C, the device 110 may also include magnetic components comprised of magnetic plates (identified individually as a first magnetic component 122a and a second magnetic component 122b, and referred to collectively as magnetic components such as for example, magnetic plates 122) positioned proximate the opposing end portions 116 of the container 112.

Referring back to FIG. 1C, the filter device 110 can have a cavity 128 that includes and/or is loaded with a filter media or sorptive media 150 through which the magnetizing or polarizing fluid, such as for example, ferrofluid is filtered. The filter media 150 can be introduced into the cavity 128 before filtration and/or during filtration (e.g., in conjunction with the ferrofluid). For example, the cavity 128 can be pre-loaded with graphene, activated carbon, boron, spinel, zeolite, sorptive media, or other suitable filtration substances, or combinations thereof. In various embodiments, the cavity 128 can be loaded with an architectural construct. In one embodiment, the container 112 may have a body portion 114 positioned between a first end portion 116a and a second end portion 116b of the container 112, and a first magnetic component 122a may be positioned proximate to a first end portion 116a and a second magnetic component 122b may be positioned proximate to the second end portion, where the first magnetic component 122a and the second magnetic component 122b generate a magnetic field across the body portion 114 of the container 112. The magnetic field may be a single field or two fields, where the magnetic field may be a temporary magnetic field, a permanent magnetic field, or an electromagnetic field. In FIGS. 1C and 1D, the magnets 126 of the first magnetic component 122a may interact with the magnets 126 of the second magnetic component 122b to form various magnetic fields such as along the length of the body portion 114 of the container 112. The positions and pole orientations of the magnets 126 in the holes 124 may be selected to alter the force and/or direction of the magnetic field between the magnetic components 122.

Referring to FIGS. 1A-1C, the device container 112 has a body portion 114 positioned between opposing end portions (identified individually as a first end portion 116a and a second end portion 116b, and referred to collectively as end portions 116). The end portions 116 may include openings 118 (identified individually as a first opening or channel 118a and a second opening or channel 118b, and referred to collectively as openings or openings comprising channels 118) that allow fluid to enter and exit the device 110 (e.g., from the passageways 102 shown in FIG. 1A). In one embodiment, the first opening or channel 118a may be configured as an inlet through which an unfiltered fluid sample enters the device 110, and the second opening or channel 118b may be configured as an outlet through which the filtered fluid sample exits the device 110. In other embodiments, the inlet and the outlet may be reversed. In various embodiments, the openings 118 may also be configured to serve as both the inlet and the outlet depending upon the direction of fluid flow through the device 110.

FIG. 1D is an enlarged isometric view of one of the magnetic plates 122. In the illustrated embodiment, the magnetic plate 122 includes a matrix of openings, apertures, or holes 124 across the face of the magnetic plate 122 and a plurality of magnets 126 positioned in selected holes 124 of the magnetic plate. The magnetic plate 122 itself may be made from magnetic materials with properties that respond to a magnetic field and/or may be made from non-magnetic materials that may support the magnets 126 positioned in holes 124 of the plate that would allow the sample to flow through.

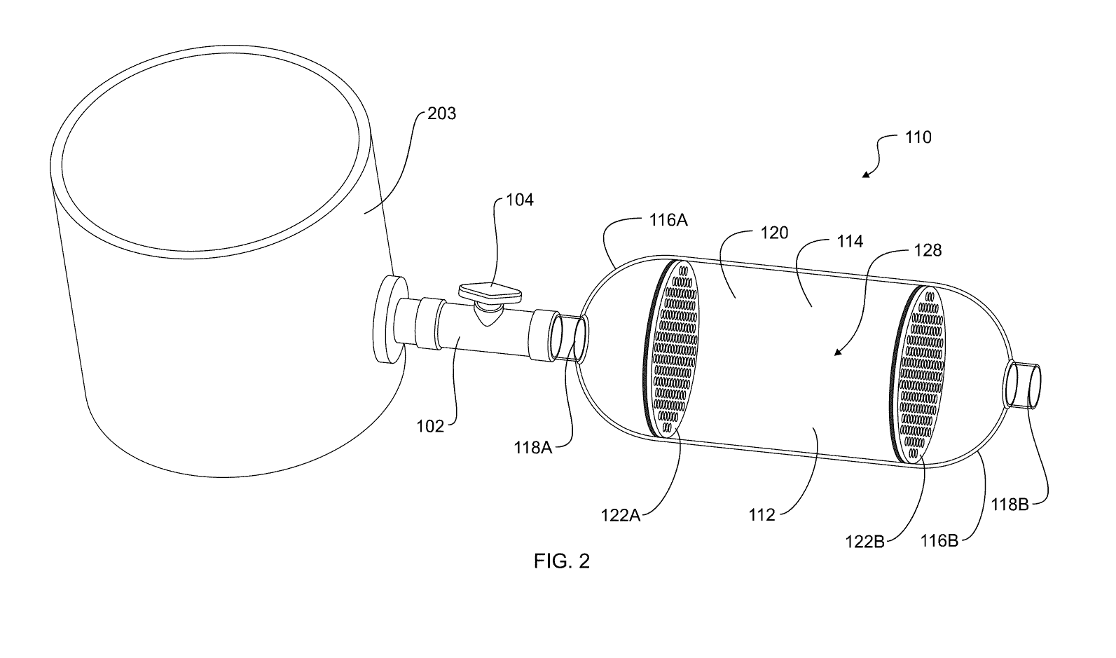

FIG. 2 is an isometric view of a device 110 configured in accordance with another embodiment of the present technology. Several features of FIG. 2 are generally similar to the features of the system 100 described above with reference to FIGS. 1A-1D. For example, FIG. 2 includes the device 110 that uses magnetic fields to filter magnetizable or polarizable fluid and/or substances presented by actions of, for example, ferrofluids. Additionally, FIG. 2 includes a reservoir 230 connected to the device 110 via the passageway 102. In various embodiments, the reservoir 230 may capture and store an unfiltered fluid sample until the filtration process occurs. When the unfiltered fluid sample is not inherently a magnetizable or polarizable fluid, the reservoir 230 may be used as a basin to magnetically infuse the fluid sample with ferrofluids, ferromagnets, or architectural constructs. For example, the fluid sample in the reservoir 230 may be loaded with an architectural construct having various specializations such as an iron edge, or certain spacing between iron edges, or other characteristics. In other embodiments, the direction of flow through the device 110 may be reversed such that purified or filtered fluid samples are captured and stored in the reservoir 230 for later use. Alternatively, there may be reservoirs 230 at both ends of the openings 118, where the reservoir at the entrance of the first opening 118a stores the unfiltered sample, and reservoir at the second opening 118b collects and stores the filtered sample.

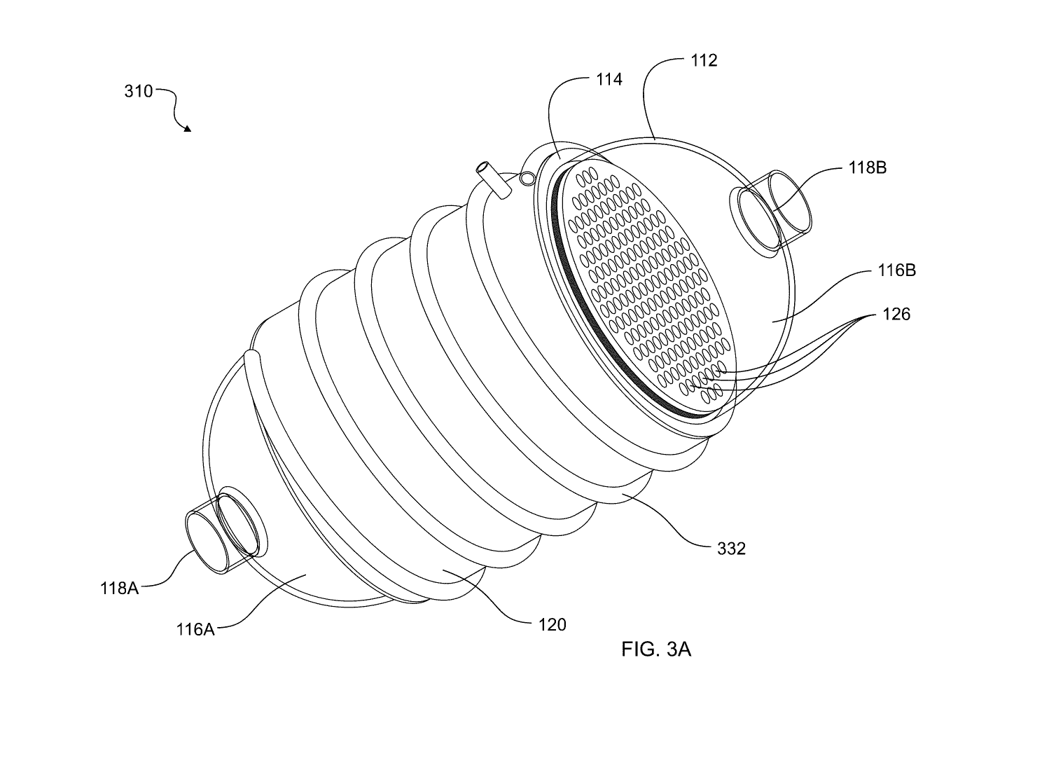

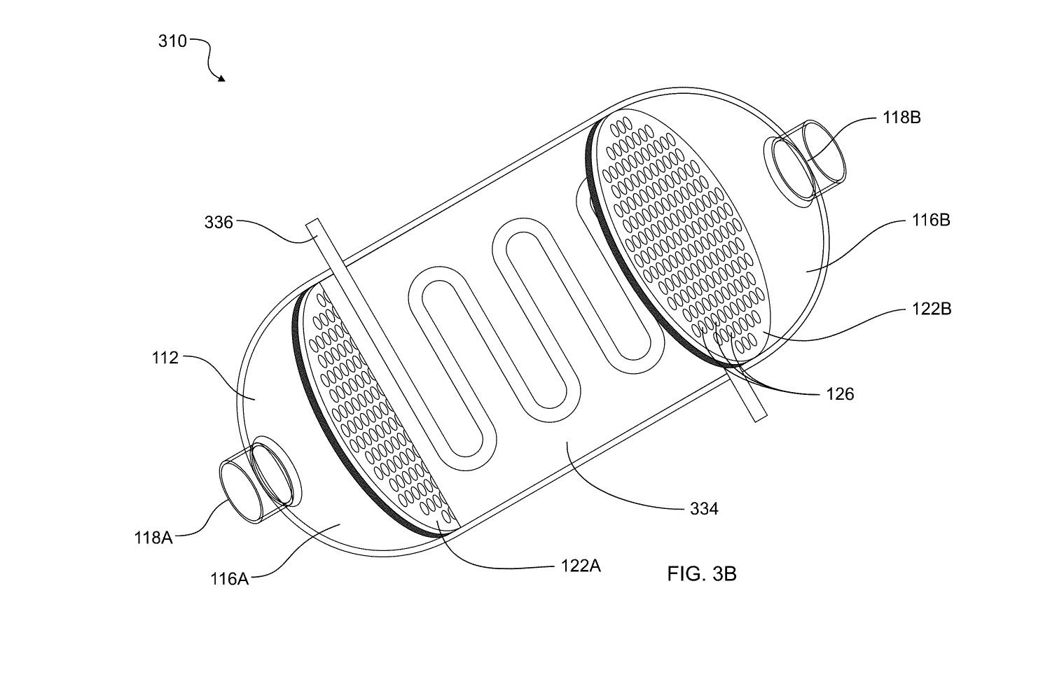

FIGS. 3A and 3B are partially transparent isometric views of a device 310 configured in accordance with another embodiment of the present technology. The device 310 includes features generally similar to the features of the filter device 110 described above with reference to FIGS. 1A-2. For example, the device 310 includes magnetic plates 122 positioned in the opposing end portions 116 of the container 112 and the coil 120 around the container 112. As shown in FIG. 3A, the device 310 further includes a heat exchanger 332 wrapped around and/or otherwise positioned on the container 112 such that the heat exchanger 332 may transfer heat to or remove heat from the device 310. In various embodiments, the heat exchanger 332 may transfer heat to the device 310 to facilitate reactions during filtration. In other embodiments, the heat exchanger 332 may remove excess heat generated from exothermic processes that may occur during filtration. For example, excess heat is typically produced during the filtration of sour gas (i.e., natural gas containing significant amounts of H₂S) when the sulfur reacts with iron (e.g., introduced via an architectural construct tailored with iron edge characteristics) to form iron sulfide. In other embodiments, the device 310 may include other heat transfer devices known in the art to transfer heat to or from the device 310, or both to and from the device.

Referring to FIG. 3B, the device 310 may further include a separator or divider 334 that may, for example, run along the length of the body portion 114 of the container 112 to form two filtration channels. For example, the two or more filtration channels shown in FIG. 3B may be loaded with different filter media and/or the magnets 126 in the magnetic plates 122 may be configured differently on either side of the separator or divider 334 to remove different substances from the fluid. In other embodiments, the device 310 may include additional separators or dividers 334 to create more filtration channels and/or the separator(s) 334 may extend a greater length through the entire container 112. The separator 334 may be made from a nonporous membrane, a polymer material, glass, and/or other suitable materials that form a barricade or divider for certain substances between filtration channels, and may be non-reactive.

As further shown in FIG. 3B, in various embodiments, the device 310 may include another heat exchanger 336 positioned on the separator 334. This inner heat exchanger 336 may be particularly beneficial where the separator 334 allows for two separate filtration cycles and thus potentially two different reactions that require heat transfer. In other embodiments, different heat transfer mechanisms known in the art may be positioned within the container 112 to add or remove heat from the device 310.

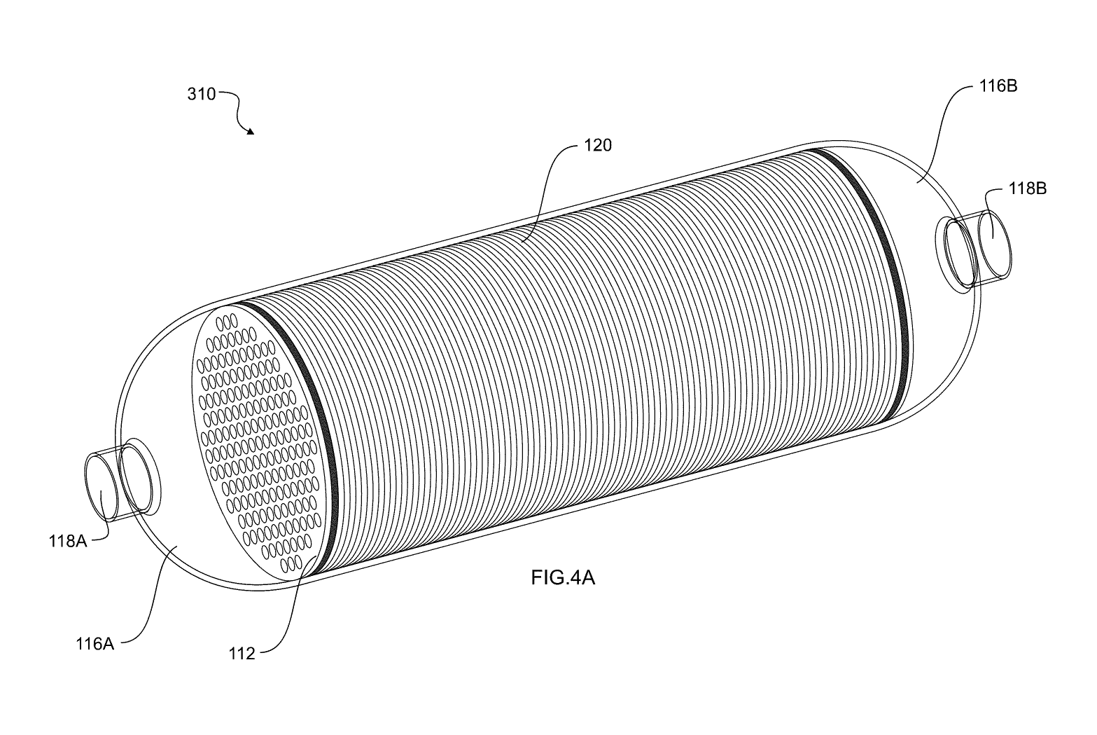

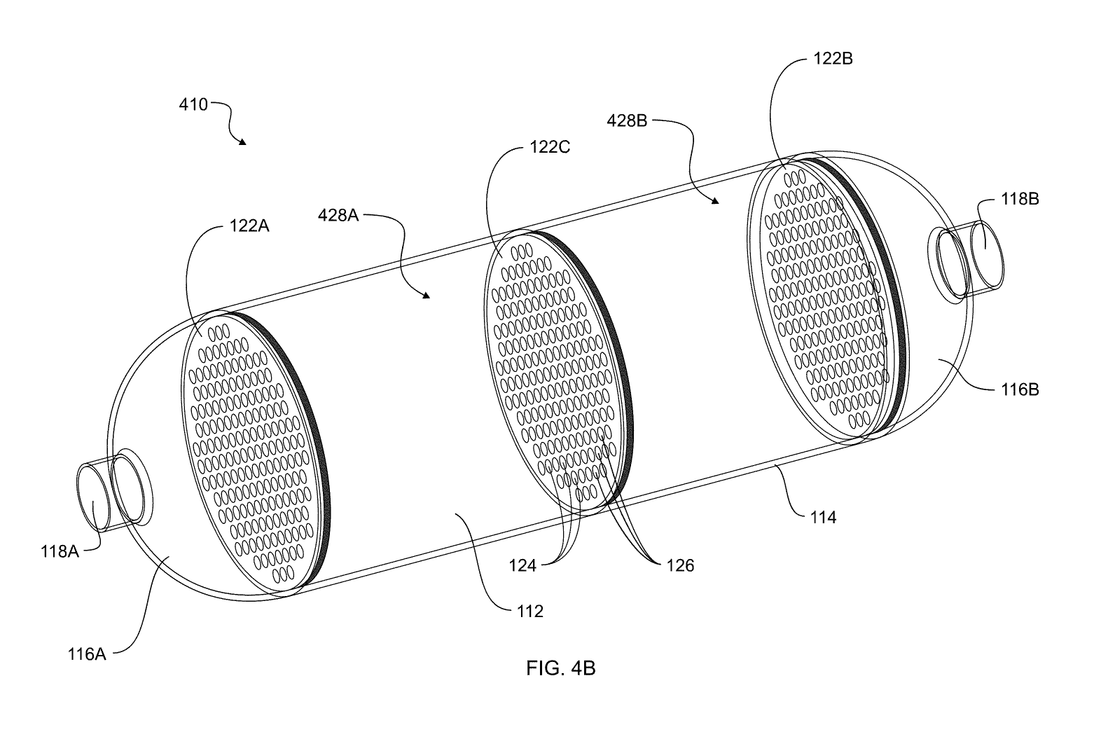

FIGS. 4A and 4B are partially transparent isometric views of a device 410 configured in accordance with a further embodiment of the present technology. The device 410 includes features generally similar to the features of the device 110 described above with reference to FIGS. 1A-1D. However, as shown in FIG. 4B, the device 410 includes a third magnetic plate 122c positioned transversely across the container 112, thereby separating the body portion 114 into a first cavity 428a and a second cavity 428b. This configuration allows the first cavity 428a to be loaded with a different filter media than the second cavity 428b such that different substances are removed from the fluid as it flows through the different cavities 428. In selected embodiments, the third magnetic plate 122c may be configured to form different magnetic fields in the first and second cavities 428a and 428b, and thus alter their filtration properties (e.g., flow speed, characteristics of the ferrofluid, removal of substances from the fluid, etc.). In other embodiments, the device 410 may include additional magnetic plates 122 to form additional cavities 428, and may accordingly filter fluids in series through a plurality of filtration stages corresponding to each of the cavities 428.

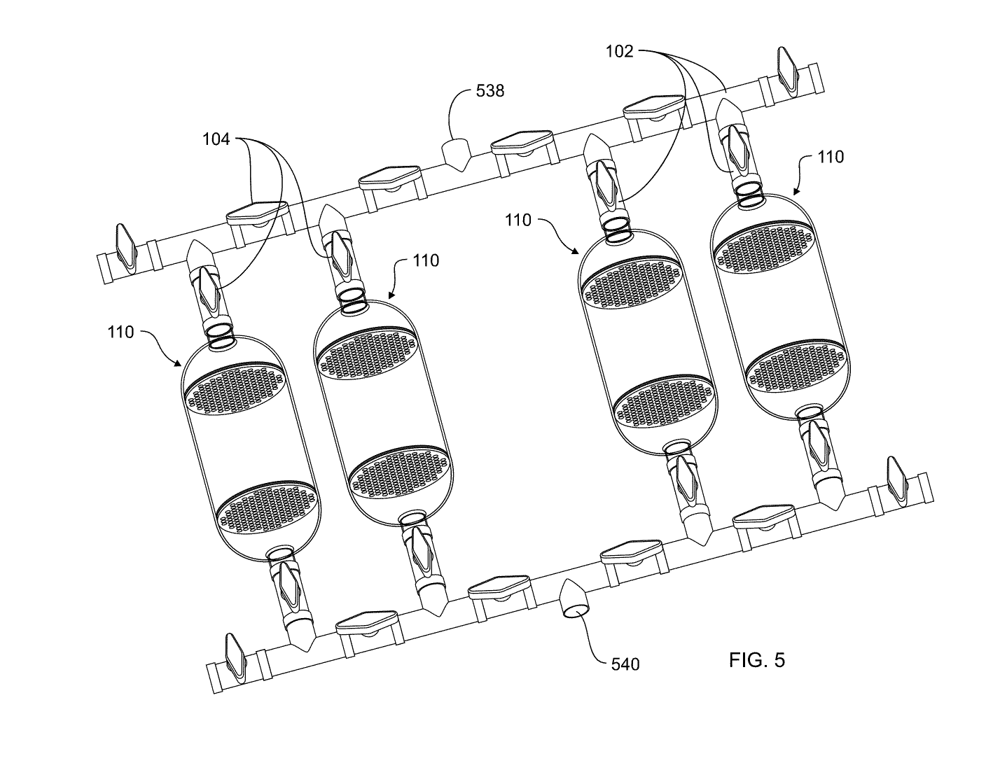

FIG. 5 is an isometric view of a plurality of devices 110 arranged in parallel with one another in accordance with an embodiment of the present technology. The devices 110 may receive a fluid sample through an inlet 538, and the passageways 102 may deliver the fluid sample to the devices 110. In various embodiments, the valves 104 may be used to direct the fluid to selected fluid devices 110 in various series, parallel or series-parallel permutations. For example, during a filtration process, the devices 110 may be in various stages of loading and/or unloading a contaminant from the fluid sample. The devices 110 may use the valves 104 to direct the fluid sample toward the devices 110 in the loading stage, while allowing the devices 110 in the unloading stage to remove the contaminant and recharge (e.g., load with a tailored architectural construct). After filtration, the fluid may exit the devices 110 via an outlet 540 opposite the inlet 538. The devices 110 may include a plurality of outlets to separately capture different purified fluid streams. Another embodiment is contemplated where the inlet 538 is not opposite the outlet 540.

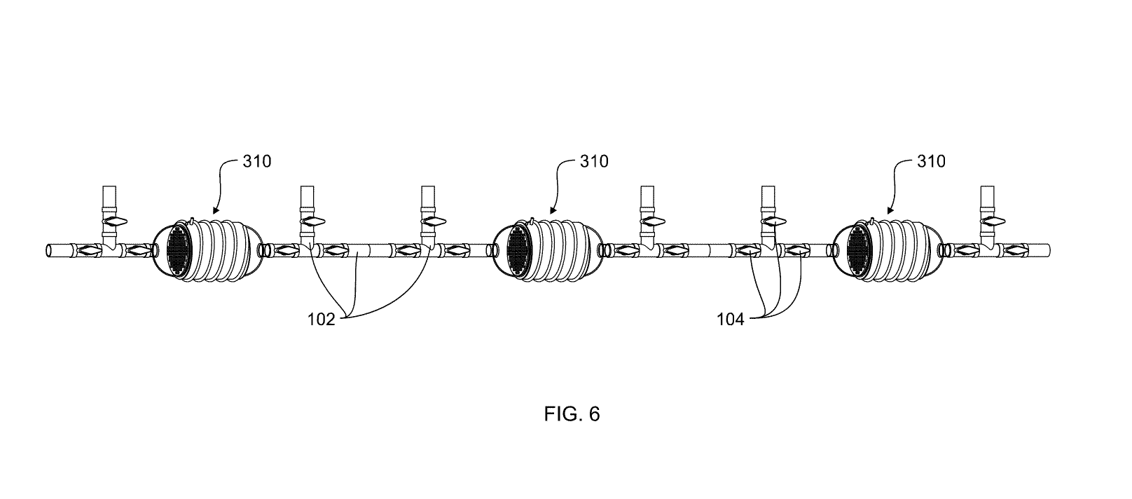

FIG. 6 is an isometric view of a plurality of devices 310 arranged in series with one another in accordance with another embodiment of the present technology. The plurality of devices 310 described above with reference to FIGS. 3A and 3B are coupled together in series rather than in parallel (e.g., as shown in FIG. 5). In various embodiments, each device 310 may be configured to remove a different substance from a fluid sample such that the different substances are sequentially removed as the fluid passes through each device 310 and the fluid becomes increasingly purified as it moves through the serially coupled devices 310. In other embodiments, the devices 310 are configured to remove the same substance from the fluid. This increases the dwell time of the fluid in the devices 310, and therefore enhances filtration. As further shown in FIG. 6, the devices 310 may also include inlet and outlet passageways 102 surrounding individual devices 310 allowing a fluid to be injected or removed from the devices 310 at various points in the series.

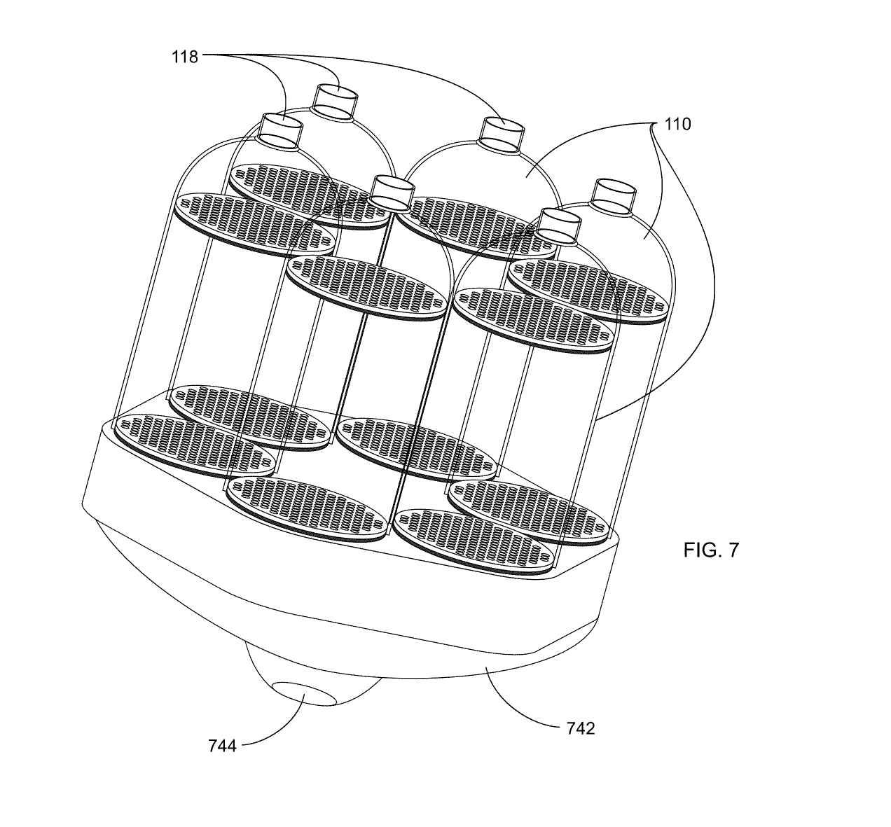

FIG. 7 is a partially transparent isometric view of the devices 110 arranged in parallel as configured in accordance with a further embodiment of the present technology. As shown in FIG. 7, the plurality of devices 110 are positioned on a manifold 742. The manifold 742 may include an opening 744 that is in fluid communication with the openings 118 of the individual devices 110. The manifold 742 may therefore form a junction between the plurality of devices 110 to either deliver fluid to the separate devices 110 or funnel fluid from the devices 110 (depending the direction of fluid flow through the devices 110). For example, in one embodiment, the opening 744 of the manifold 742 may be configured as an inlet or opening such that fluid flows into the manifold 742 and divides into the individual devices 110. The devices 110 may be configured to remove the same or different contaminants from the fluid. In various embodiments, the manifold 742 may further include a fluid distribution element comprising fluid distribution channels that direct the fluid substantially evenly into the devices 110 and, optionally, pre-filter the fluid before it enters the devices 110 (e.g., as described in U.S. patent application Ser. No. ______, filed Aug. 13, 2012; entitled “FLUID DISTRIBUTION FILTER HAVING SPIRAL FILTER MEDIA AND ASSOCIATED METHODS AND SYSTEMS,” and incorporated by reference above). In other embodiments, the opening 744 of the manifold 742 is configured as an outlet that collects the filtered fluid from the devices 110. In another embodiment, manifolds 742 may be positioned at both openings 118, or just at one of the inlet or outlet openings 118 at either end of the devices.

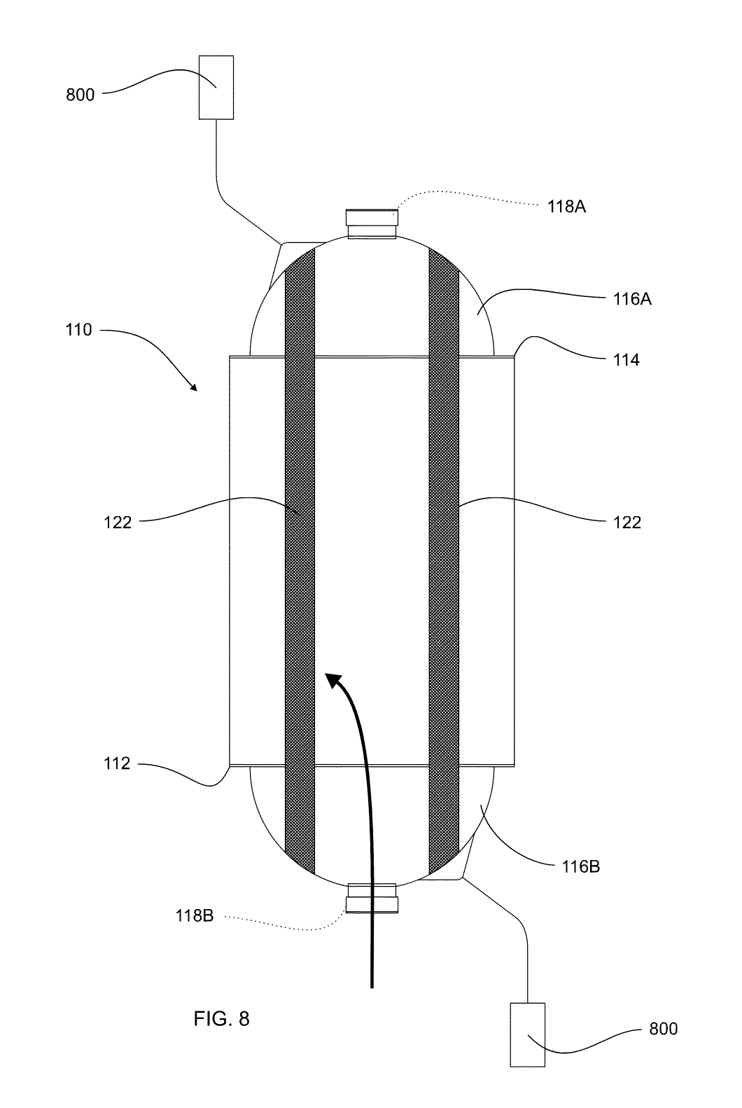

FIG. 8 illustrates an embodiment wherein the magnetic elements 122 are positioned longitudinally within the device 110. The fluid sample may enter into the device 110, as illustrated by the arrows, from either opening 118a or 118b, and may be alternatively attracted towards one magnetic component 122 or the other. The magnetic components 122 of the device 110 may be controlled by separate control elements 800, although a single control element may be employed. The control elements 800 may control the strength, the frequency, or both the strength and frequency of a magnetic field generated by each of the magnetic components 122.

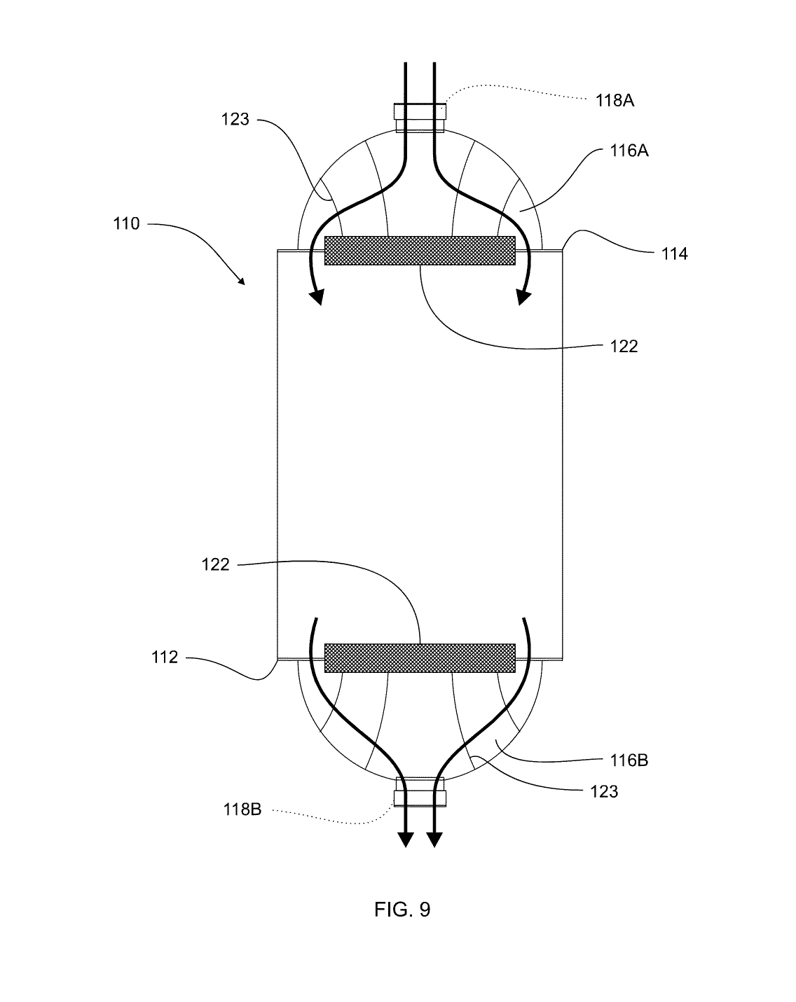

FIG. 9 illustrates another embodiment in accordance with the invention where the diameter and shape of the magnetic components 122 may be less than the diameter of the container 112 or of the body portion 114 of the device 110, where the diameter is the distance perpendicular to the flow of fluid or width of the container 112, while the length of the container 112 or body portion 114 as depicted in FIG. 9 is the length. In this embodiment as illustrated, the magnetic components 122 are affixed to the housing of the device by an arm or arms 123. As can be seen, the fluid may enter one opening 118a of the device 110, or may be drawn into one opening 118a of the device 110 by a magnetic force as applied by the magnetic components 122, at which point the fluid will enter and pass through the filter media when drawn, for example, by a magnetic force on the magnetic fluid and fluid sample. A desired component or element of the fluid, such as for example, hydrogen sulfide (H₂S), may be retained within the filter media 150 of the body portion 114 of the device 110, and the remaining components may be released as shown by the arrows in FIG. 9 through a second opening 118b, or a select desired component of the fluid may be released as shown by the arrows in FIG. 9 through an opening 118b while the remaining components may be retained within the device 110.

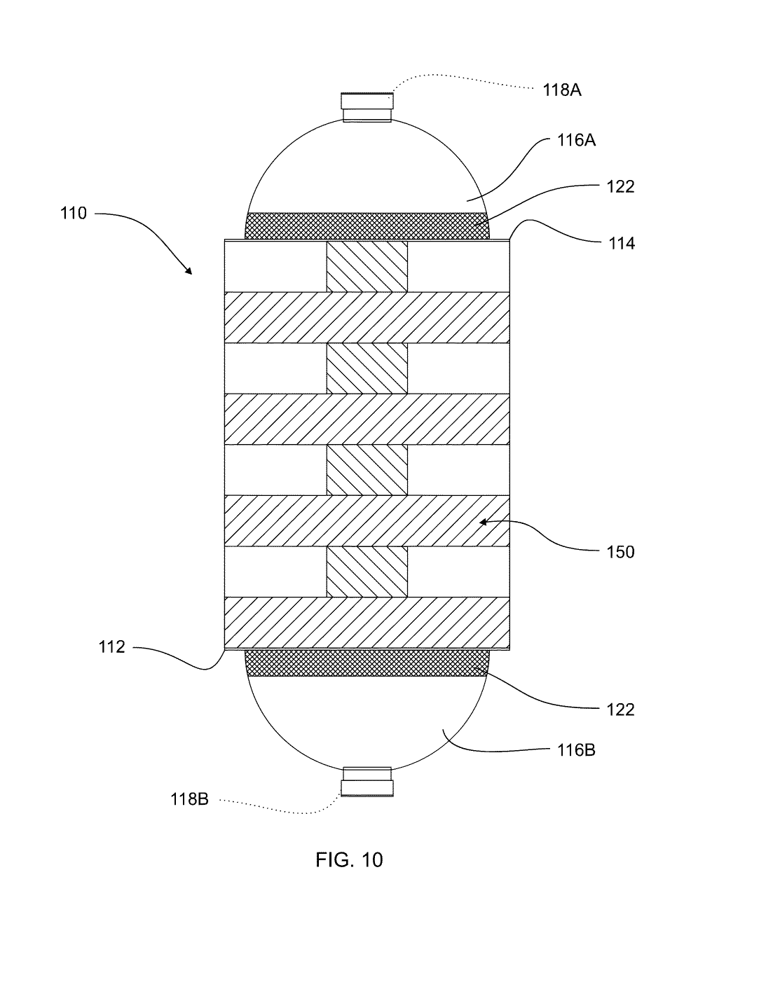

FIG. 10 illustrates yet another embodiment of the invention where a filter media or sorptive media 150 is positioned between magnetic elements 122. The filter media 150 may be prepared or designed so that each level or partition allows for subtractive filtration by allowing, for example, for constituents of a fluid, where the fluid initially has four constituents, to pass through a first partition of a filter media 150, then the remaining three constituents of the fluid to pass through a second partition of a filter media 150, then the remaining two constituents of the fluid to pass through a third partition of a filter media 150, and then the remaining one constituent being allowed to pass through or be retained in a fourth partition of a filter media 150, where the flow of fluid is in the direction of opening 118a to opening 118b.

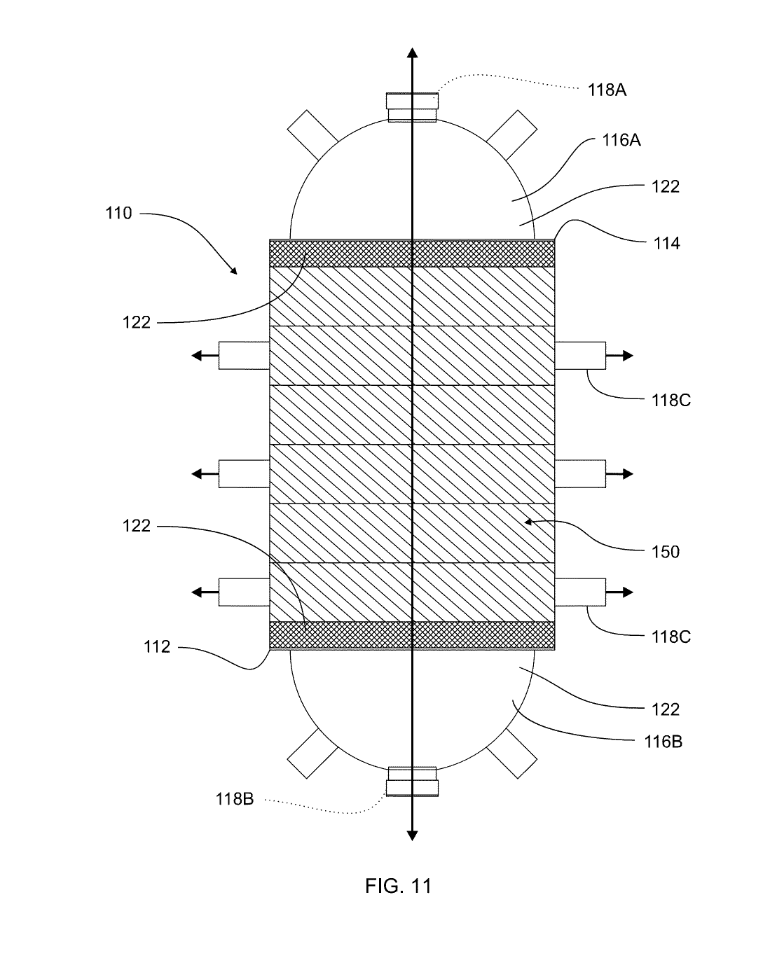

FIG. 11 illustrates another embodiment in accordance with the invention where a filter media 150 is positioned within the housing chamber or container 112 of the device 110, and, depending on the control element (not shown, 800) of the magnetic component 122, a fluid may be drawn one way or forced to return back in the direction that it entered the device 110. In this embodiment, additional openings 118c are located variously along the housing 112 of the device 110 to, for example, release portions of filtered fluids at various points from a single device 110. Thus, for example, when the filter media 150 of parallel partitions, layers, or zones are differentiated by a size or density gradient, a large or dense compound from a fluid sample may only pass through an initial zone of the filter media 150 and be arrested at an initial zone of the sorptive media 150 closest to the opening 118 in which the fluid sample entered, for example, opening 118a. A second smaller or less dense compound from the fluid sample may pass through the first zone of the sorptive media 150 and be retained in a second zone of the filter media 150, and a third even smaller and less dense compound may pass through the first two zones of the filter media 150 and be retained in the third zone of the filter media 150, and/or pass completely through the device 110 for further processing. At such time as when the filtration and separation process has been sufficiently carried out, which may be assessed by taking samples at various points along the length of the body portion 114 of the device 110 and/or from within the filter media 150, through, for example, openings 118c, the separated components of the fluid located in each partition of the filter media 150 may be released from the separate ports 118c.

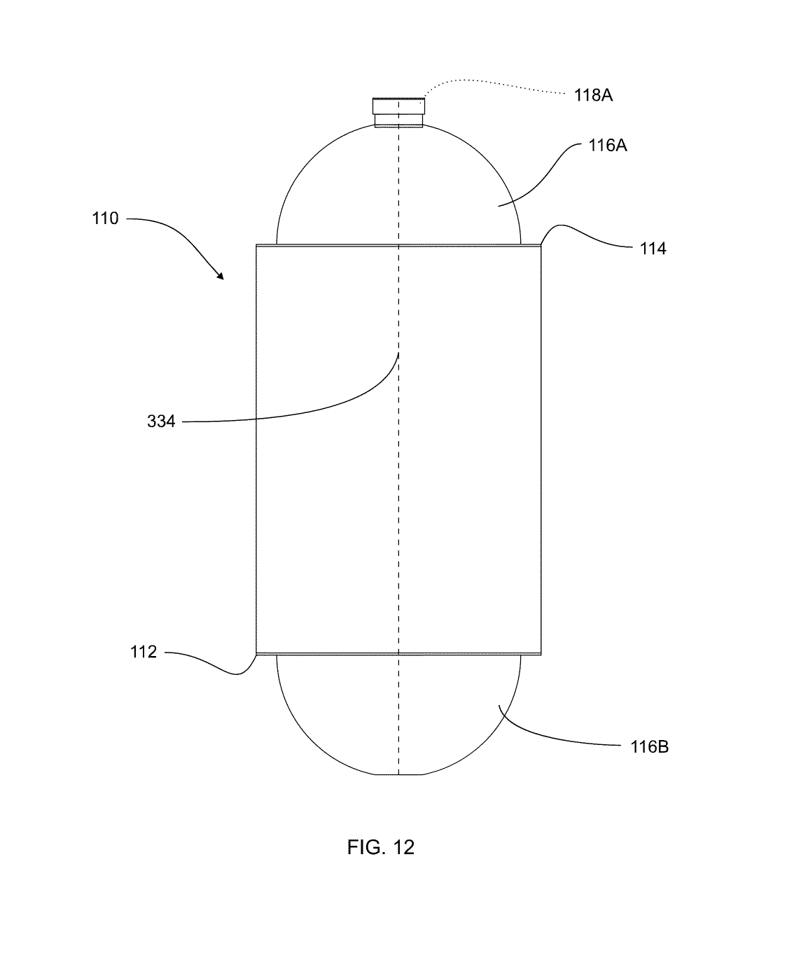

FIG. 12 illustrates yet a further embodiment which may or may not be combined with any of the other embodiments described here. The device 110 may be configured to have a single port or opening for receiving or releasing a fluid 118d, which may also have one or more, or at least one, separators or dividers 334 that extends at least partially or completely through the length of the body portion 114 of the container 112 of the device 110. The separator or divider 334 may be partially or completely permeable as indicated by the dashed line. The presence of one separator 334, for example, forms two filtration channels, which may be configured to run in parallel, while removing different constituents or contaminants from the fluid. Alternatively, one side of the separator 334 may receive the fluid while the other side of the separator may release the constituents of the sample through opening or port 118d.

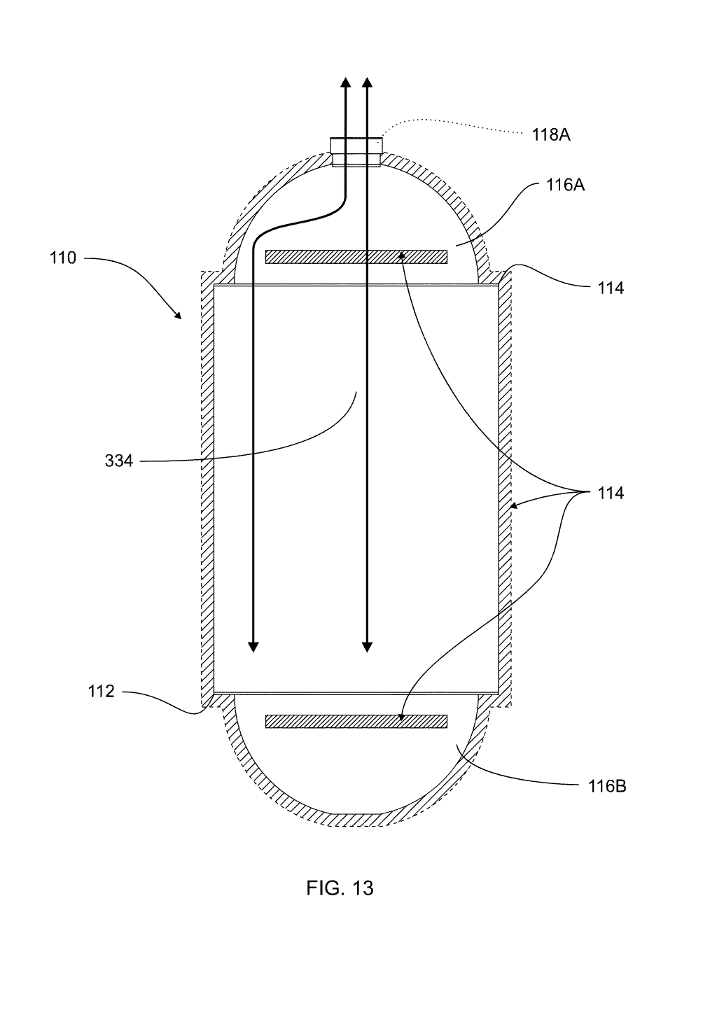

FIG. 13 illustrates alternative embodiments of a single opening or port 118d of device 110, where the opening may comprise a channel where a fluid may be received or released through opening 118d. The device 110 may comprise one or more, or at least one, magnetic component 122 located or positioned inside, outside, around, or partially around the container 112. The magnetic component 112 may extend partially or completely around the container 112, either within or on the outside of the container 112 as shown by the dotted hatched lines encompassing the entire container 112 of the device 110, and/or the magnetic component 122 may be located inside or within the container 112. The magnetic component 122 may comprise of two magnetic components 122 located at opposite ends 116a and 116b of the container 112. The magnetic component 112 may extend the entire width or partial width of the container 112. The fluid may flow through or around the magnetic component(s) 122. In order for the fluid to flow through the magnetic component 122, the magnetic component 122 may be permeable. If the magnetic component 122 is impermeable or solid, then the fluid would flow around the magnetic component 122, since the magnetic component 122 does not extend the full width of the container 112.

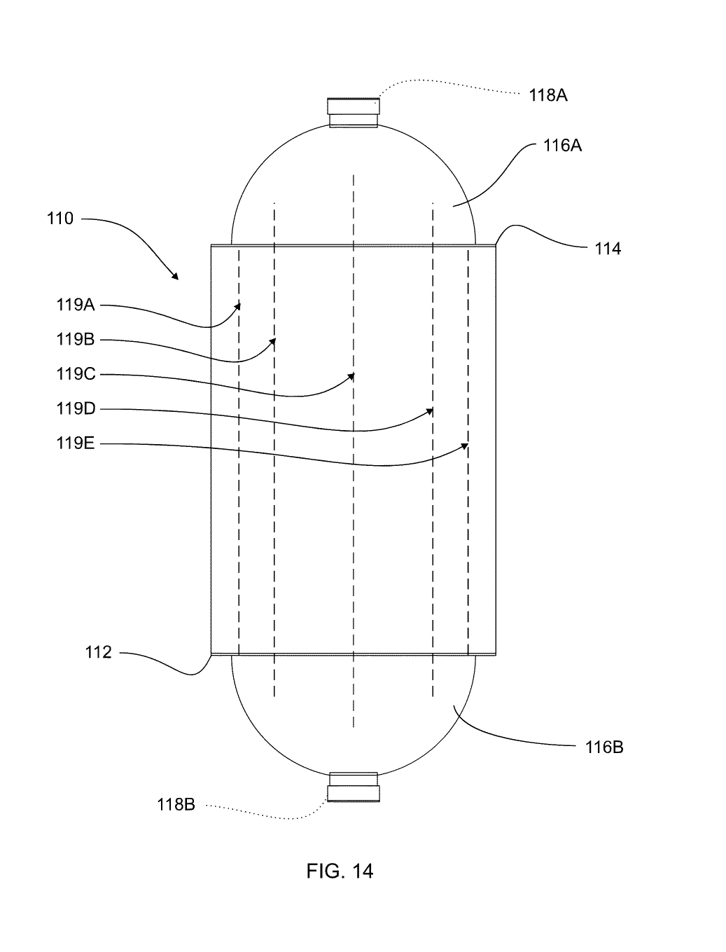

FIG. 14 illustrates an embodiment where one or more possible activating elements 119 (119a, 119b, 119c, 119d, 119e), are positioned internally, as part of the container, or externally of the device 110, for initiating, assisting in the progress of, or assisting in the termination of a reaction. FIG. 14 shows the device 110 with activating elements 119a-119e at varying exemplary positions. The device 110 may have one or more activating elements 119 positioned parallel or perpendicular to the direction of fluid flow. The activating elements 119a and 119e may be positioned externally to the reaction chamber, in a wall of the container 112 as shown in FIG. 14, or internally adjacent to the side wall of the container 112. FIG. 14 illustrates additional and/or alternative positions of the activating elements 119, such as for example, 119b and 119d, which may be positioned or situated a distance away from the side walls, while activating element 119c may be positioned along the midline of the device, parallel to the direction of flow.

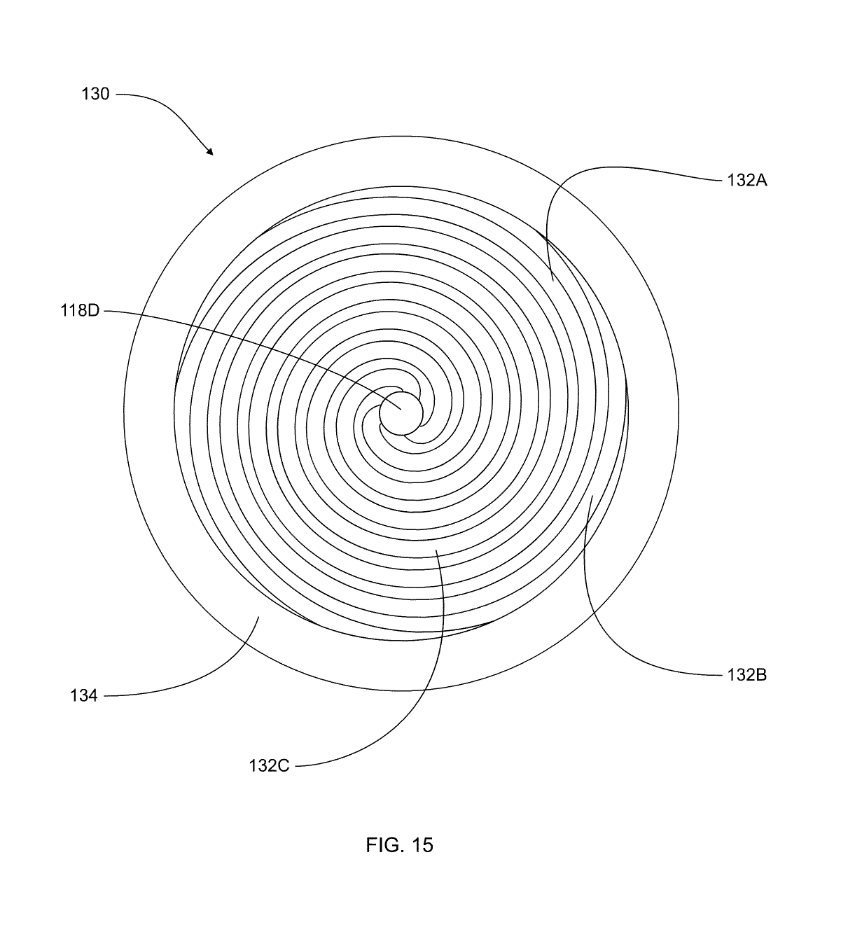

FIG. 15 is a fluid distribution element 130 that may be configured with the device 110 in accordance with a further embodiment of the present technology. A fluid distribution element 130 may distribute a fluid, either directly or indirectly by assisting with fluid distribution. The fluid distribution element 130 may be directly, indirectly, or fluidly attached to a device 110, preferably at an opening 118 for receiving a fluid, where the fluid distribution element may cap an opening 118 of a device 110. The fluid distribution element 130 may be a magnetic component itself, or a magnetic component 122 may be placed, preferably behind the fluid distribution element 130. Another embodiment is directed to a fluid distribution element 130 that filters a fluid prior to simultaneously to entering the device 110. The device 110 may have a fluid distribution element 130, comprising one or more fluid distribution channels 132 (132a, 132b, 132c), where a container 112 may have a collection sleeve 134, which may collect a constituent or constituents of the fluid that was received in the device 110. The collection sleeve 134 may be a wall of the device 110, where the wall is sufficiently thick to collect a fluid, a constituent, or constituents; or alternatively, the collection sleeve 134 may be within the container 112 and adjacent to the wall of the container 112. The collection sleeve 134 may be fluidly attached to an opening 118 for releasing a fluid, a constituent, or constituents. The fluid distribution element 130 may cap or cover, or partially cover, the entire width of an opening 118 (118a, 118b) of the device 110. Sorptive media may also be in the container 112, behind the fluid distribution element 130 and/or the magnetic component 122. FIG. 14 is a front end view of a member that enhances or improves distribution of fluid into the device 110 where the fluid may be inserted into a center opening 118d for receiving fluids and proceeds through the fluid distribution channels 132a, 132b, and 132c to enter the container 112. The container 112 may contain a first layer may contain a sorptive media, preferably graphene, which filters constituents of the fluid. In one embodiment, contaminants or constituents, such as for example, salt (NaCl), are separated from salt water, such that the purified or filtered water exits through the walls of the first layer into the collection sleeve 134 of the device 110. The contaminants or solutes may flow through the sorptive media and exit the device 110 through a port or opening for releasing constituents of the fluid 118 (e.g., 118b). The purified or filtered water that may collect in the collection sleeve 134, may then exit the device 110 by an opening, outlet, or port that releases constituents, which may be the same opening or outlet 118b as that used for releasing fluids or constituents of the fluid, or a different outlet or openings 118c for releasing constituents of the fluid.

From the foregoing, it will be appreciated that specific embodiments of the technology have been described here for purposes of illustration, but that various modifications may be made without deviating from the disclosure. For example, the devices shown in the Figures are cylindrical with dome-shaped end portions. However, in other embodiments, the devices may have a variety of other shapes (e.g., cones, rectangular prisms, cubes, spheres, etc.), aspect ratios, and must not necessarily be symmetrical about the end portions. Certain aspects of the new technology described in the context of particular embodiments may be combined or eliminated in other embodiments. For example, any one of the devices described above can be used in conjunction with any of the devices. Additionally, the devices shown in the Figures may be combined with one another to form an integrated system. Moreover, while advantages associated with certain embodiments of the new technology have been described in the context of those embodiments, other embodiments may also exhibit such advantages, and not all embodiments need necessarily exhibit such advantages to fall within the scope of the technology. Accordingly, the disclosure and associated technology may encompass other embodiments not expressly shown or described herein.

Features of the various embodiments described above may be combined to provide further embodiments. All of the patents, patent application publications, patent applications, and non-patent publications, including but not limited to, published articles, abstracts, books, and reference manuals, referred to in this specification and/or listed in the Information Disclosure Statement are incorporated herein by reference, in their entirety to more fully describe the state of the art to which the disclosure pertains. Aspects of the disclosure may be modified, if necessary, to employ architectural constructs with various configurations, and concepts of the various patents, applications, and publications to provide yet further embodiments of the disclosure.

These and other changes may be made to the disclosure in light of the above-detailed description. In general, in the following claims, the terms used should not be construed to limit the disclosure to the specific embodiments disclosed in the specification and the claims, but should be construed to include all systems and methods that operate in accordance with the claims. Accordingly, the invention is not limited by the disclosure, but instead its scope is to be determined broadly by the following claims. Various alternatives and modifications can be devised by those skilled in the art without departing from the disclosure. Accordingly, the present disclosure is intended to embrace all such alternatives, modifications and variations that fall within the scope of the appended claims.

The examples in the specification further describe and demonstrate embodiments within the scope of the present disclosure. The examples are given solely for the purpose of illustration and are not to be constructed as limitations of the present disclosure, as many variations thereof are possible without departing from the spirit and scope of the disclosure.

What is claimed is:

1. A device for treating a fluid, comprising:
a container having an opening and a magnetic component; and
a sorptive media loaded within the container,
wherein the sorptive media is positioned relative to the magnetic component so that when the fluid is in the container, the magnetic component exerts a magnetic field on the fluid and the sorptive media.

2. The device of claim 1, wherein the opening is configured for receiving and releasing the fluid.

3. The device of claim 1, wherein the opening comprises a first channel for receiving a fluid and a second channel for releasing a fluid.

4. The device of claim 1, wherein the device further comprises a magnetizable fluid loaded within the container.

5. The device of claim 1, wherein the magnetic component comprises a coil around the container of the device.

6. The device of claim 1, wherein the magnetic component further comprises a second magnetic component.

7. The device of claim 6, wherein the container has a body portion between a first end portion and a second end portion of the container; and wherein
the first magnetic component is positioned proximate to the first end portion; and
the second magnetic component is positioned proximate to the second end portion,
wherein at least a portion of the sorptive media is positioned between the first magnetic component and the second magnetic component in the body portion of the container, and
wherein the first magnetic component and the second magnetic component exert a magnetic field across the body portion of the container.

8. The device of claim 1, wherein the magnetic component may be positioned inside, within, outside, around, or partially around the container, or combinations thereof.

9. The device of claim 1, wherein the magnetic field is a permanent magnetic field or an electromagnetic field.

10. The device of claim 6, wherein the second magnetic component induces a temporary magnetic field, a permanent magnetic field, or an electromagnetic field.

11. The device of claim 1, wherein the magnetic component may be permeable.

12. The device of claim 11, wherein the permeable magnetic component may have a plurality of openings and magnets arranged in selected openings to generate a magnetic field.

13. The device of claim 1, wherein the magnetic component is a permanent magnet.

14. The device of claim 1, wherein the device further comprises a separator that extends the length of container.

15. The device of claim 1, wherein the container further comprises an activating element that assists in the progression of or termination of a reaction.

16. The device of claim 15, wherein the activating element is a heat exchanger.

17. The device of claim 15, wherein the reaction is activated thermally, chemically, mechanically, electrically, ultrasonically, optically, or by a catalyst, or combinations thereof.

18. The device of claim 15, wherein the activating element comprises one or more activating elements positioned inside, within, outside, around, partially around the container, or combinations thereof.

19. The device of claim 1, further comprises a control element that controls the magnetic field.

20. The device of claim 19, wherein the control element controls the strength, the frequency, or both the strength and the frequency of the magnetic field.
